(19) United States
(12) Patent Application Publication
(10) Pub. No.: US 2010/0076625 A1
(43) Pub. Date: Mar. 25, 2010

(54) FLIGHT CONTROL COCKPIT MODES IN DUCTED FAN VTOL VEHICLES

(76) Inventor: Raphael Yoeli, Tel-Aviv (IL)

Correspondence Address: NIXON & VANDERHYE, PC, 901 NORTH GLEBE ROAD, 11TH FLOOR, ARLINGTON, VA, 22203, US

(21) Appl. No.: 12/516,743

(22) PCT Filed: Nov. 29, 2007
(86) PCT No.: PCT/IL07/01475

§ 371 Date: Aug. 10, 2009

Related U.S. Application Data
(60) Provisional application No. 60/867,829, filed on Nov. 30, 2006.

(51) Int. Cl. G05D 1/00; G05D 1/08; B64C 29/00; B64C 39/00

(52) U.S. Cl. 701/4; 244/175

(57) ABSTRACT

A flight control system for aircraft, such as for a vehicle with a ducted fan propulsion system which also produces rotary moments and side forces for control purposes. The flight control system of the present invention is designed in a manner that will ensure the safety of the vehicle in event of a malfunction in any one of its channels and enable the flight to continue down to a safe landing.

### FIELD OF THE INVENTION

The present invention relates to flight control systems in general, and particularly to their use with VTOL (Vertical Take-Off and Landing) aircraft.

### BACKGROUND OF THE INVENTION

Many different types of VTOL aircraft have been proposed where the weight of the vehicle in hover is carried directly by rotors or propellers, with the axis of rotation perpendicular to the ground. One well known vehicle of this type is the conventional helicopter which includes a large rotor mounted above the vehicle fuselage. Other types of vehicles rely on propellers that are installed inside circular cavities, shrouds, ducts or other types of nacelle, where the propeller or rotor is not exposed, and where the flow of air takes place inside the circular duct. Most ducts have uniform cross-sections with the exit area (usually at the bottom of the duct when the vehicle is hovering) being similar to that of the inlet area (at the top of the duct). Some ducts, however, are slightly divergent, having an exit area that is larger than the inlet area, as this was found to increase efficiency and reduce the power required per unit of lift for a given inlet diameter. Some ducts have a wide inlet lip in order to augment the thrust obtained, especially in hover.

VTOL vehicles are usually more challenging than fixed wing aircraft in terms of stability and control. The main difficulty rises from the fact that, contrary to fixed wing aircraft which accelerate on the ground until enough airspeed is achieved on their flight surfaces, VTOL vehicles hover with sometimes zero forward airspeed. For these vehicles, the control relies on utilizing the rotors or propellers themselves, or the flow of air that they produce to create control forces and moments and forces around the vehicle's center of gravity (CG).

One method, which is very common in helicopters, is to mechanically change, by command from the pilot, the pitch of the rotating rotor blades both collectively and cyclically, and to modify the main thrust as well as moments and/or inclination of the propeller's thrust line that the propeller or rotor exerts on the vehicle. Some VTOL vehicles using ducted or other propellers that are mounted inside the vehicle also employ this method of control. Some designers choose to change only the angle of all the blades using ducted or other propellers that are mounted inside the vehicle for this method of control. The angle of all the blades may be changed simultaneously (termed collective control) to avoid the added complexity of changing the angle of each blade individually (termed cyclic control). On vehicles using multiple fans which are relatively far from the CG, different collective control settings can be used on each fan to produce the desired control moments.

The disadvantage of using collective controls, and especially cyclic controls, lies in their added complexity, weight and cost. Therefore, a simple thrust unit that is also able to generate moments and side forces, while still retaining a simple rotor not needing cyclic blade pitch angle changes, has an advantage over the more complex solution. The main problem is usually the creation of rotational moments of sufficient magnitude required for control.

One traditional way of creating moments on ducted fans is to mount a discrete number of vanes at or slightly below the exit section of the duct. These vanes, which are immersed in the flow exiting the duct, can be deflected to create a side force. Since the vehicle's center of gravity is in most cases at a distance above these vanes, the side force on the vanes also creates a moment around the vehicle's CG.

However, one problem associated with vanes mounted at the exit of the duct in the usual arrangement as described above, is that even if these are able to create some moment in the desired direction, they cannot do so without creating at the same time a significant side force that has an unwanted secondary effect on the vehicle. For such vanes mounted below the vehicle's CG (which is the predominant case in practical VTOL vehicles), these side forces cause the vehicle to accelerate in directions which are usually counter-productive to the result desired through the generation of the moments by the same vanes, thereby limiting their usefulness on such vehicles.

The Chrysler VZ-6 VTOL flying car uses vanes on the exit side of the duct, together with a small number of very large wings mounted outside and above the duct inlet area.

However, in the VZ-6, the single wing and the discrete vanes were used solely for the purpose of creating a steady, constant forward propulsive force, and not for creating varying control moments as part of the stability and control system of the vehicle.

The Hornet unmanned vehicle developed by AD&D, also experimented with using either a single, movable large wing mounted outside and above the inlet, or, alternatively using a small number of vanes close to the inlet side. However these were fixed in angle and could not be moved in flight.

Another case that is sometimes seen is that of vanes installed radially from the center of the duct outwards, for the purpose of creating yawing moments (around the propeller's axis).

### SUMMARY OF THE INVENTION

The present invention provides a flight control system for aircraft, such as for a vehicle with a ducted fan propulsion system which also produces rotary moments and side forces for control purposes. The flight control system of the present invention is designed in a manner that will ensure the safety of the vehicle in event of a malfunction in any one of its channels and enable the flight to continue down to a safe landing.

In one exemplary but non-limiting aspect, the invention relates to a ducted fan VTOL vehicle comprising:

a thrust-generating system of plural controlled ducted air movement units having controlled propellers or fans located within respective ducts and having means capable of generating independent forces and moments in any of six fundamental degrees of freedom while operating within at least some part of a flight envelope, the six degrees of freedom comprising linear movements of the vehicle Vx, Vy, Vz and angular movements of the vehicle ωx, ωy, ωz along the axes x, y, z wherein each movement may be independently controlled;

a system of pilot initiated input transducers M1-Mn coupled to pilot initiated control actuators accessible to a pilot's position in the vehicle and producing controlled outputs corresponding to pilot initiated inputs, at least some of the transducers M1-Mn being coupled to primary pilot initiated flight control actuators, the primary pilot initiated flight control actuators being those actuators that, if active, require substantially continuous pilot attention and control inputs for maintaining primary control of vehicular movement;

autopilot and flight control systems configured to provide output flight control signals controlling physical parameters of the thrust-generating system in response to input signals;

the control systems being connected to the system of pilot initiated input transducers and adapted to control physical parameters of the thrust-generating system in response to outputs of selected ones of the pilot initiated input transducers and in response to additional vehicle transducers;

wherein the control systems are configured, while operating in at least some part of a flight envelope, to utilize four or less primary pilot initiated flight control actuators for primary control of the vehicle while also automatically controlling all six independent degree(s) of freedom in vehicular movement.

In another aspect, the invention relates to a flight control system for a VTOL vehicle having at least two lift fans with adjustable-pitch propellers, and at least two thrust fans with adjustable pitch propellers, and a plurality of adjustable directional vanes and associated with each of the lift and thrust fans; the control system comprising:

a. plural controls respectively controlling six independent degrees of freedom of vehicular movement; and

b. at least one control computer subsystem programmed to adjust the directional vanes and to control the pitch of the propellers of the lift and thrust fans to enable the VTOL vehicle to hover at a non-zero roll or pitch angle.

Exemplary but non-limiting embodiments will be described in further detail in connection with the drawings identified below.

### BRIEF DESCRIPTION OF THE DRAWINGS

The invention is herein described, by way of example only, with reference to the accompanying drawings, wherein:

FIG. 1 illustrates one form of VTOL aircraft vehicle useful in understanding the present invention;

FIG. 2 illustrates only one of the ducted fans in the aircraft of FIG. 1;

FIG. 3 is a sectional view along line III-III of FIG. 2;

FIG. 4 is a diagram illustrating the positioning of the vanes of FIG. 3 in one direction to produce a lateral force in one direction.

FIG. 5 is a diagram illustrating the positioning of the vanes of FIG. 3 to produce a lateral force in the opposite direction.

FIG. 6 illustrates a modification in the construction of the vanes wherein each of the vanes is split into two halves, each half of all the vanes being separately pivotal from the other half of all the vanes to produce a rotary moment force about the duct longitudinal axis;

FIG. 7 is a diagram illustrating the construction of one of the vanes and the manner for pivoting it;

FIG. 8 illustrates an alternative construction of one of the vanes and the manner for pivoting it;

FIG. 9 illustrates one arrangement that may be used for providing two cascades or assemblies of vanes at the inlet end of the duct of FIG. 9;

FIG. 10 illustrates another arrangement that may be used for providing two cascades or assemblies of vanes at the inlet end of the duct;

FIG. 11 illustrates a VTOL aircraft vehicle including a single ducted fan for propulsion and control purposes;

FIG. 12 is a view similar to that of FIG. 3 but illustrating the provision of a cascade or plurality of vanes also at the exit end of the duct;

FIGS. 13a-13d illustrate various pivotal positions of the two cascades of vanes in the ducted fan of FIG. 12, and the forces produced by each such positioning of the vanes;

FIG. 14 is a top view diagrammatically illustrating another construction wherein the vanes extending across the inlet of the duct are divided into two groups together producing the desired net horizontal control force;

FIGS. 15a and 15b diagrammatically illustrate the manner in which the desired net horizontal control force is produced by the vanes of FIG. 14;

FIG. 16 is a view corresponding to that of FIG. 14 but illustrating a variation in the vane arrangement for producing the desired net horizontal control force;

FIG. 17 illustrates a VTOL vehicle with two ducted fans useful in understanding the present invention;

FIG. 18 illustrates an alternative construction with four ducted fans;

FIG. 19 illustrates a construction similar to FIG. 17 with free propellers, i.e., unducted fans;

FIG. 20 illustrates a construction similar to FIG. 18 with free propellers;

FIG. 21 illustrates a construction similar to that of FIG. 17 but including two propellers, instead of a single propeller, mounted side-by-side in a single, oval shaped duct at each end of the vehicle;

FIGS. 22a, 22b and 22c are side, top and rear views, respectively, illustrating another VTOL vehicle useful in understanding the present invention and including pusher propellers in addition to the lift-producing propellers;

FIG. 23 is a diagram illustrating the drive system in the vehicle of FIGS. 22a-22c;

FIG. 24 is a pictorial illustration of a vehicle constructed in accordance with FIGS. 22a-22c and 23;

FIG. 25a-25d illustrate examples of various tasks and missions capable of being accomplished by the vehicle of FIG. 24;

FIGS. 26a and 26b are side and top views, respectively, illustrating another VTOL vehicle constructed in accordance with the present invention;

FIG. 27 is a diagram illustrating the drive system in the vehicle of FIGS. 26a and 26b;

FIGS. 28a and 28b are side and top views, respectively, illustrating a VTOL vehicle constructed in accordance with any one of FIGS. 22a-27 but equipped with deployable stub wings, the wings being shown in these figures in their retracted stowed positions;

FIGS. 28c and 28d are views corresponding to those of FIGS. 28a and 28b but showing the stub wings in their deployed, extended positions;

FIG. 29 is a perspective rear view of a vehicle constructed in accordance with any one of FIGS. 22a-27 but equipped with a lower skirt for converting the vehicle to a hovercraft for movement over ground or water;

FIG. 30 is a perspective rear view of a vehicle constructed in accordance with any one of FIGS. 22a-23 but equipped with large wheels for converting the vehicle for ATV (all terrain vehicle) operation;

FIGS. 31a-31e are a pictorial illustration of an alternative vehicle arrangement wherein the vehicle is relatively small in size, having the pilot's cockpit installed to one side of the vehicle. Various alternative payload possibilities are shown.

FIG. 32 is a pictorial illustration of a vehicle constructed typically in accordance with the configuration in FIGS. 31a-31e but equipped with a lower skirt for converting the vehicle to a hovercraft for movement over ground or water.

FIG. 33 is a pictorial illustration of a cockpit control configuration, constructed and operative in accordance with a preferred embodiment of the present invention;

FIG. 34 is a simplified block diagram of a multi-channel flight control system, constructed and operative in accordance with a preferred embodiment of the present invention;

FIG. 35 is a table summarizing control and effect in various flight modes, operative in accordance with a preferred embodiment of the present invention;

FIGS. 36-40, which is an alternative flight control system arrangement, constructed an operative in accordance with a preferred embodiment of the present invention;

FIGS. 41-58 relate to a flight control cockpit modes in Ducted Fan VTOL Vehicles.

### DESCRIPTION OF PREFERRED EMBODIMENTS

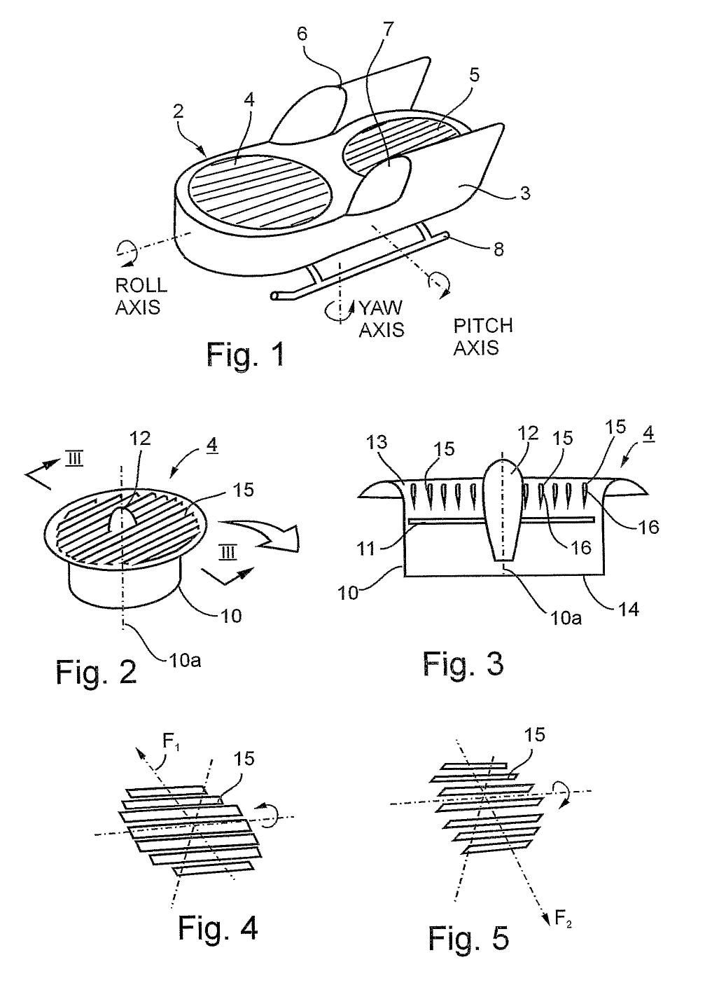

The vehicle illustrated in FIG. 1, and therein generally designated 2, is a VTOL aircraft including a frame or fuselage 3 carrying a ducted fan propulsion unit 4 at the front, and another similar propulsion unit 5 at the rear. The vehicle payload is shown at 6 and 7, respectively, on opposite sides of the fuselage, and the landing gear as shown at 8.

FIGS. 2 and 3 more particularly illustrate the structure of propulsion unit 4, which is the same as propulsion unit 5. Such a propulsion unit includes a duct 10 carried by the fuselage 3 with the vertical axis 10a of the duct parallel to the vertical axis of the vehicle. Propeller 11 is rotatably mounted within the duct 10 about the longitudinal axis 10a of the duct. Nose 12 of the propeller faces upwardly, so that the upper end 13 of the duct constitutes the air inlet end, and the lower end 14 of the duct constitutes the exit end. As shown particularly in FIG. 3, the upper air inlet end 13 is formed with a funnel-shaped mouth to produce a smooth inflow of air into the duct 10, which air is discharged at high velocity through the exit end 14 of the duct for creating an upward lift force.

To provide directional control, the duct 10 is provided with a plurality of parallel, spaced vanes 15 pivotally mounted to, and across, the inlet end 13 of the duct. Each of the vanes 15 is pivotal about an axis 16 perpendicular to the longitudinal axis 10a of the duct 10 and substantially parallel to the longitudinal axis of the vehicle frame 2, to produce a desired horizontal control force in addition to the lift force applied to the vehicle by the movement of air produced by the propeller 11. Thus, as shown in FIG. 4, if the vanes 15 are pivoted in one direction about their respective axes, they produce a desired control force in the direction of the arrow F1 in FIG. 4; and if they are pivoted in the opposite direction, they produce a desired control force in the direction of the arrow F2 in FIG. 5. As shown in FIG. 3 (also FIGS. 7, 8, 12), the vanes 15 are of a symmetric airfoil shape and are spaced from each other a distance approximately equal to the chord length of the vanes.

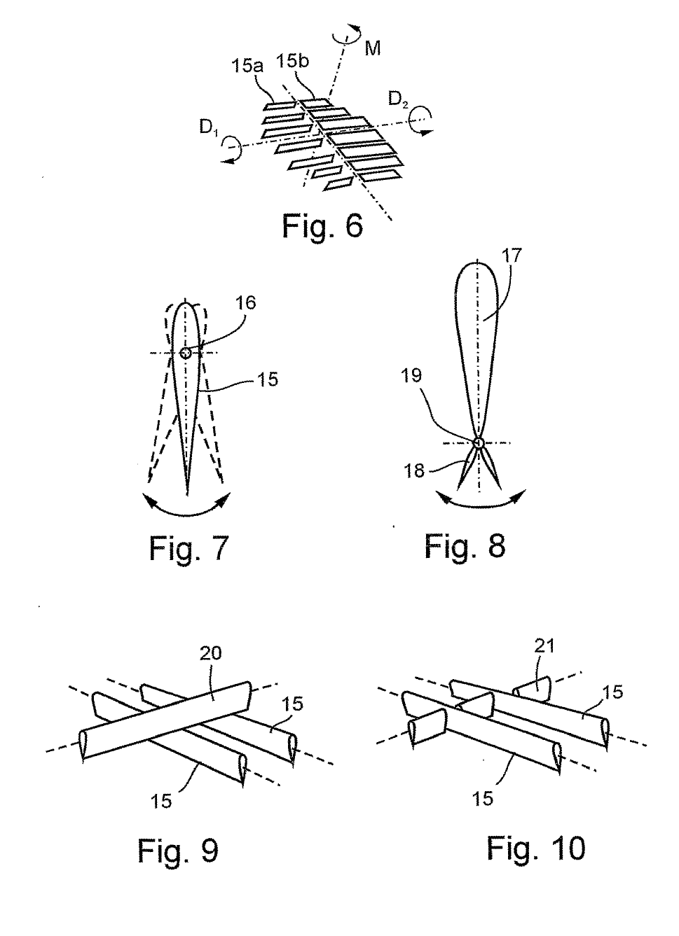

FIG. 6 illustrates a variation wherein each of the vanes 15, instead of being pivotally mounted as a unit for its complete length to produce the desired side control force is split into two half-sections, as shown at 15a and 15b in FIG. 6, with each half-section separately pivotal from the other half-section. Thus, all the half-sections 15a may be pivoted as a unit in one direction as shown by arrow D1, and all the half-sections 15b may be pivoted in the opposite direction as shown by arrow D2, to thereby produce any desired side force or rotary moment in addition to the lift force applied to the vehicle by the propeller.

As shown in FIG. 7, each of the vanes 15 is pivotally mounted about axis 16 passing through a mid portion of the vane. FIG. 8 illustrates a modification wherein each vane includes a fixed section 17, which constitutes the main part of the vane, and a pivotal section or flap 18 pivotally mounted at 19 to the trailing side of the fixed section. It will thus be seen that the pivotal section or flap 18 may be pivoted to any desired position in order to produce the desired control force in addition to the lift.

FIG. 9 illustrates a variation wherein the ducted fan (4 and/or 5 FIG. 1) includes a second plurality or cascade of parallel, spaced vanes, one of which is shown at 20, pivotally mounted to and across the inlet end 13 of the duct 10. Thus, each of the vanes 20 of the second plurality is closely spaced to the vanes 15 and is pivotal about an axis perpendicular to the pivotal axis of the vanes 15, as well as to the longitudinal axis 10a of the duct.

In the variation illustrated in FIG. 9, the two cascades of vanes 15, 20, are arranged in parallel, spaced planes. FIG. 10 illustrates a variation wherein the two cascades of vanes at the inlet end of the duct are intermeshed. For this purpose, each of the vanes 21 of the second plurality would be interrupted so as to accommodate the crossing vanes 15 of the first plurality, as shown in FIG. 10. Another possible arrangement would be to have the vanes of both cascades interrupted for purposes of intermeshing.

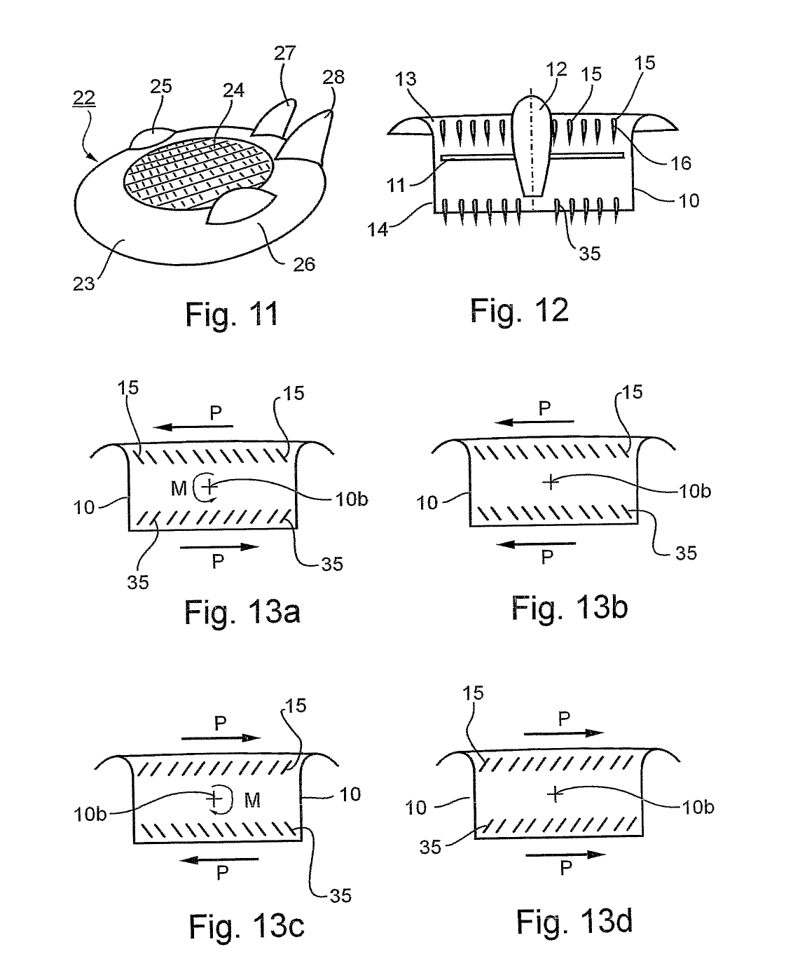

FIG. 11 illustrates a VTOL aircraft vehicle, therein generally designated 22, including a single ducted fan 24 carried centrally of its fuselage 23. Such a vehicle could include the arrangement of vanes illustrated in either FIG. 9 or in FIG. 10 to provide the desired control forces and moments in addition to the lift forces. In such a vehicle, the payload may be on opposite sides of the central ducted fan 24, as shown at 25 and 26 in FIG. 11. The vehicle may also include other aerodynamic surfaces, such as rudders 27, 28 to provide steering and other controls.

FIG. 12 illustrates a further embodiment that may be included in either of the vehicles of FIGS. 1 and 11 wherein the duct 10 also has a second plurality or cascade of parallel, spaced vanes, but in this case, the second plurality are pivotally mounted to and across the exit end 14 of the duct 10. Thus, as shown in FIG. 12, the duct 10 includes the first plurality or cascade of blades 15 mounted to and across the inlet end 13 of the duct, and a second plurality or cascade of blades 35 mounted to and across the exit end 14 of the duct 10, also perpendicular to the longitudinal axis of the duct and substantially parallel to the longitudinal axis of the vehicle frame. Each assembly or cascade 15, 35 of the vanes may be pivoted independently of the other to produce selected side forces or rotary moments about the duct's transverse axis 10b for pitch or roll control of the vehicle.

This is more clearly shown in the diagrams of FIGS. 13a-13d. Thus, when the two cascades of vanes 15, 35, are pivoted in opposite directions, they produce a rotary moment about the transverse axis 10b of the duct 10 in one direction (e.g., counter-clockwise as shown in FIG. 13a); when they are pivoted in the same direction, they produce a side force in one direction (e.g. left) as shown in FIG. 13b when pivoted in opposite directions but opposite to the arrangement shown in FIG. 13a, they produce a rotary moment in the opposite clockwise direction as shown in FIG. 13c; and when they are pivoted in the same direction but opposite to that shown in FIG. 13b, they produce a side force in the opposite (e.g. right) direction, as shown in FIG. 13d.

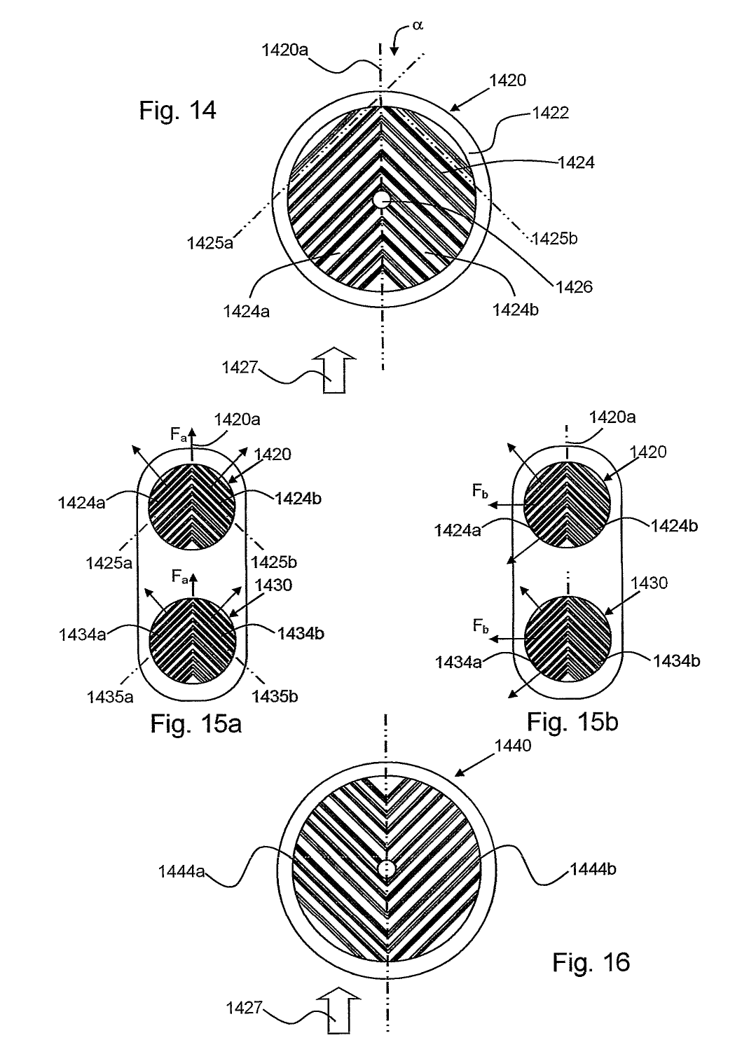

FIG. 14 is a top view illustrating another construction of ducted fan propulsion unit, generally designated 1420, including a duct 1422 having a plurality of vanes 1424 extending across the inlet end of the duct. In this case, the vanes 1424 are divided into a first group of parallel vanes 1424a extending across one-half the inlet end of the duct 1422, and a second group of parallel vanes 1424b extending across the remaining half of the inlet end of the duct.

FIG. 14 also illustrates the nose 1426 of the propeller within the duct 1422. The propeller is rotatably mounted within the duct 1422 about the longitudinal axis of the duct, with the nose 1426 of the propeller centrally located at the air inlet end of the duct such that the air discharged at a high velocity through the opposite end of the duct creates an upward lift force.

As shown in FIG. 14, the first group of parallel vanes 1424a extending across one half of the inlet end of the duct 1422 are pivotal about axes 1425a at a predetermined acute angle α with respect to the longitudinal axis 1420a of the vehicle frame and thereby of the direction of movement of the vehicle as shown by arrow 1427; and that the second group of parallel vanes extending across the remaining half of the inlet end of the duct are pivotal about axes 1425b at the same predetermined angle α, but in the opposite direction, with respect to the longitudinal axis 1420a of the vehicle frame. The two groups of vanes 1424a, 1424b are selectively pivotal to produce a desired net horizontal control force in addition to the lift force applied to the vehicle.

The foregoing operations are illustrated in the diagrams of FIGS. 15a and 15b. Both FIGS. 15a and 15b illustrate the control forces generated when the vehicle includes two ducted fan propulsion units 1420, 1430, at the opposite ends of the vehicle and coaxial with the vehicle longitudinal axis 1420a. It will be appreciated that comparable forces are produced when the vehicle is equipped with only one ducted fan propulsion unit shown in FIG. 14.

FIG. 15a illustrates the condition wherein the two groups of vanes 1424a, 1424b are pivoted to equal angles about their respective axes 1425a, 1425b. The vanes thus produce, in addition to the lift force, control forces of equal magnitude and angles on opposite sides of the vehicle longitudinal axis 1420a, so as to produce a net force, shown at Fa, coaxial with the vehicle longitudinal axis 1420a.

The two groups of vanes 1434a, 1434b of the rear propulsion unit 1430 are pivotal in the same manner about their respective pivotal axes 1435a, 1435b, and thereby produce a net force Fa also coaxial with the vehicle longitudinal axis 1420a.

FIG. 15b illustrates a condition wherein the two groups of vanes 1424a, 1424b in the fore propulsion unit 1420, and the two groups of vanes 1434a, 1434b in the aft propulsion unit 1430, are pivoted about their respective axes to unequal angles, thereby producing net side forces Fb at an angle to the vehicle longitudinal axis 1420a. Thus, by controlling the pivot angles of the vanes 1424a, 1424b and 1434a, 1434b about their respective pivotal axes, a net control force may be generated as desired in the plane of the vanes.

FIG. 16 illustrates a ducted fan propulsion unit, generally designated 40, also including two groups of vanes 1444a, 1444b, extending across one-half of the inlet of the duct 1442 and pivotally mounted about axes 1445a, 1445b at a predetermined angle, (e.g., 45° to the longitudinal axis 1440a of the vehicle. In this case, however, the vanes 1444a, 1444b are oriented in the forward direction, rather than in the aft direction as in FIG. 14, but the operation, and the forces generated by the vanes, are basically the same as described above with respect to FIGS. 14, 15a, 15b.

It will be appreciated that any of the foregoing arrangements may be used in any of the above-described air vehicles to produce the desired control forces in addition to the lift forces. The vanes are not intended to block air flow, but merely to deflect air flow to produce the desired control forces. Accordingly, in most applications the vanes would be designed to be pivotal no more than 15° in either direction, which is the typical maximum angle attainable before flow separation. Since the control forces and moments are generated by horizontal components of the lift forces on the vanes themselves, the vanes should preferably be placed on the intake side of the propeller as far from the center of gravity of the vehicle as possible for creating the largest attainable moments. The same applies if vanes are provided on the axis side of the ducts.

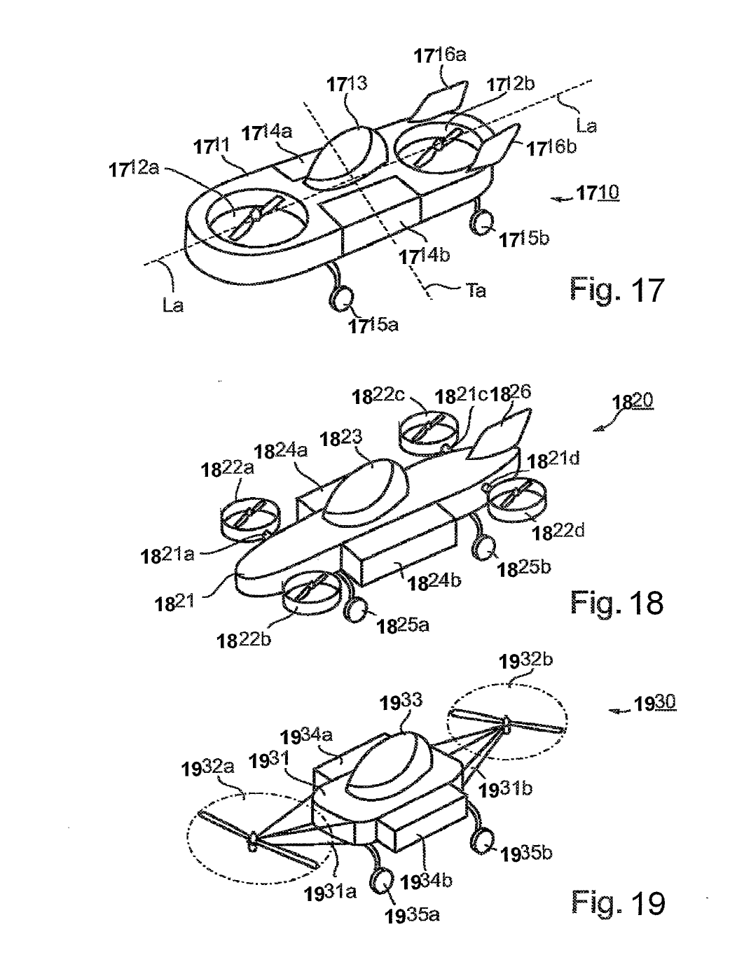

FIG. 17 illustrates an alternative vehicle construction in accordance with the present invention. In FIG. 17, a vehicle, generally designated 1710, includes a fuselage 1711 having a longitudinal axis LA and a transverse axis TA. Vehicle 1710 further includes two lift-producing propellers 1712a, 1712b carried at the opposite ends of the fuselage 1711 along its longitudinal axis LA and on opposite sides of its transverse axis TA. Lift-producing propellers 1712a, 1712b are ducted fan propulsion units extending vertically through the fuselage and rotatable about vertical axes to propel the air downwardly and thereby to produce an upward lift.

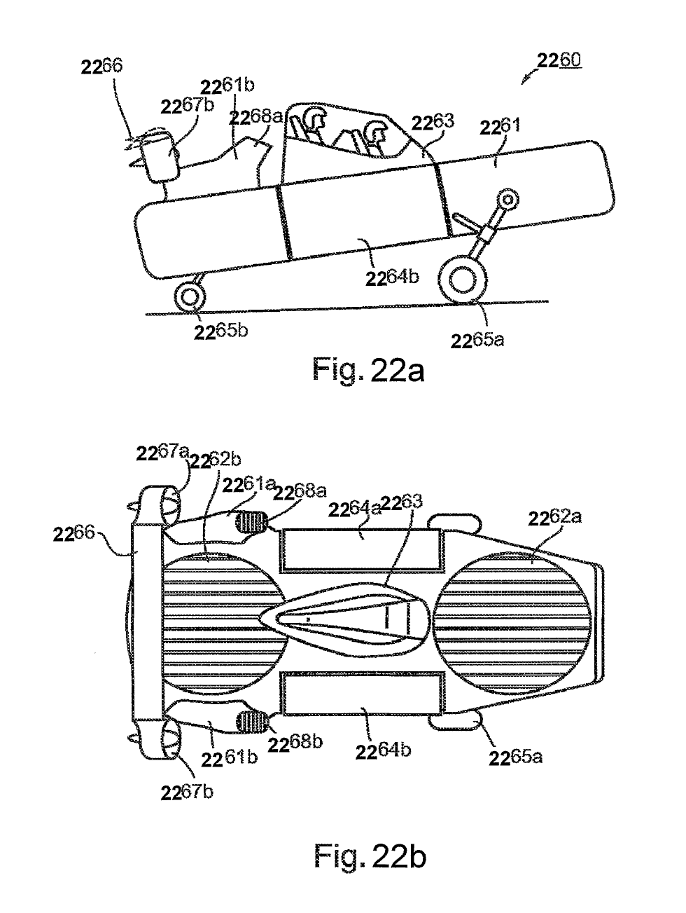

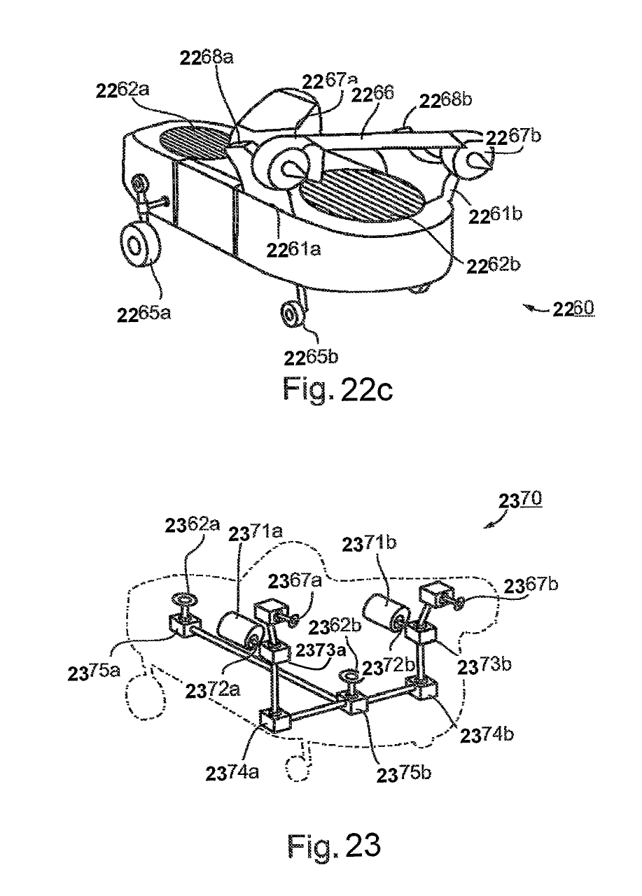

Vehicle 1710 further includes a pilot's compartment 1713 formed in the fuselage 1711 between the lift-producing propellers 1712a, 1712 and substantially aligned with the longitudinal axis LA and transverse axis TA of the fuselage. The pilot's compartment 1713 may be dimensioned so as to accommodate a single pilot or two (or more) pilots, as shown, for example, in FIG. 22a.

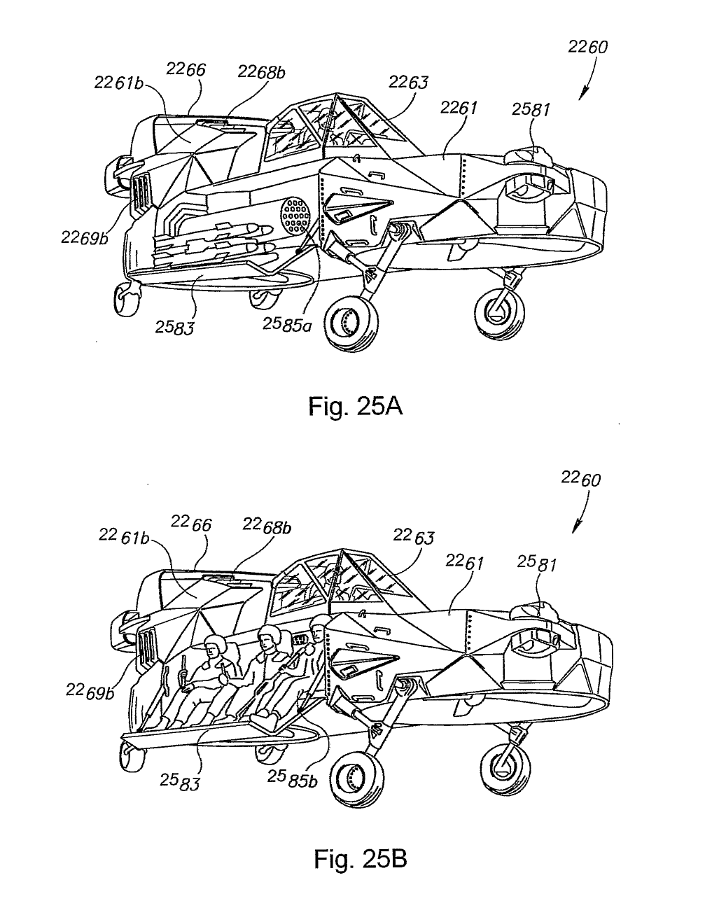

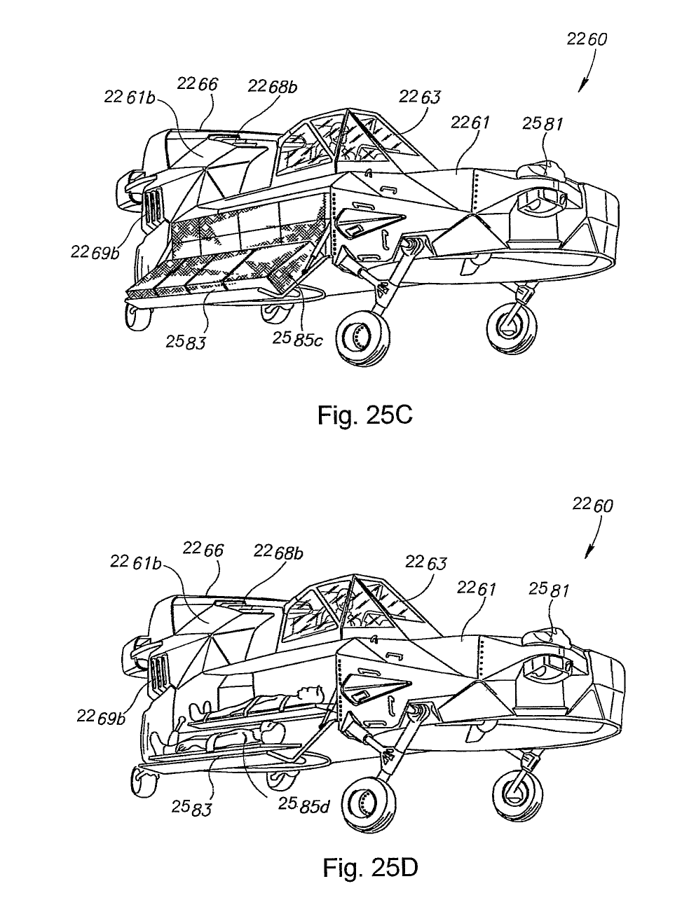

Vehicle 1710 illustrated in FIG. 17 further includes a pair of payload bays 1714a, 1714b formed in the fuselage 1711 laterally on the opposite sides of the pilot's compartment 1713 and between the lift-producing propellers 1712a, 1712b. The payload bays 1714a, 1714b shown in FIG. 17 are substantially flush with the fuselage 1711, as will be described more particularly below with respect to FIGS. 22a-22c and the pictorial illustration in FIGS. 25a-25d. Also described below, particularly with respect to the pictorial illustrations of FIGS. 25a-25d, are the wide variety of tasks and missions capable of being accomplished by the vehicle when constructed as illustrated in FIG. 17 (and in the later illustrations), and particularly when provided with the payload bays corresponding to 14a, 14b of FIG. 17.

Vehicle 1710 illustrated in FIG. 17 further includes a front landing gear 1715a and a rear landing gear 1715b mounted at the opposite ends of its fuselage 1711. In FIG. 17 the landing gears are non-retractable, but could be retractable as in later described embodiments. Aerodynamic stabilizing surfaces may also be provided, if desired, as shown by the vertical stabilizers 1716a, 1716b carried at the rear end of fuselage 1711 on the opposite sides of its longitudinal axis LA.

FIG. 18 illustrates another vehicle construction in accordance with the present invention. In the vehicle of FIG. 18, therein generally designated 1820, the fuselage 1821 is provided with a pair of lift-producing propellers on each side of the transverse axis of the fuselage. Thus, as shown in FIG. 18, the vehicle includes a pair of lift-producing propellers 1822a, 1822b at the front end of the fuselage 1821, and another pair of lift-producing propellers 1822c, 1822d at the rear end of the fuselage. The lift-producing propellers 1822a-1822d shown in FIG. 18 are also ducted fan propulsion units. However, instead of being formed in the fuselage 1821, they are mounted on mounting structures 1821a-1821d to project laterally of the fuselage.

Vehicle 1820 illustrated in FIG. 18 also includes the pilot's compartment 1823 formed in the fuselage 1821 between the two pairs of lift-producing propellers 1822a, 1822b and 1822c, 1822d, respectively. As in the case of the pilot's compartment 1713 in FIG. 17, the pilot's compartment 1823 in FIG. 18 is also substantially aligned with the longitudinal axis LA and transverse axis TA of the fuselage 1821.

Vehicle 1820 illustrated in FIG. 18 further includes a pair of payload bays 1824a, 1824b formed in the fuselage 1821 laterally of the pilot's compartment 1823 and between the two pairs of lift-producing propellers 1822a-1822d. In FIG. 18, however, the payload bays are not formed integral with the fuselage, as in FIG. 17, but rather are attached to the fuselage so as to project laterally on opposite sides of the fuselage. Thus, payload bay 1824a is substantially aligned with the lift-producing propellers 1822a, 1822c on that side of the fuselage; and payload bay 1824b is substantially aligned with the lift-producing propellers 1822b and 1822d at that side of the fuselage.

Vehicle 1820 illustrated in FIG. 18 also includes a front landing gear 1825a and a rear landing gear 1825b, but only a single vertical stabilizer 1826 at the rear end of the fuselage aligned with its longitudinal axis. It will be appreciated however, that vehicle 20 illustrated in FIG. 2 could also include a pair of vertical stabilizers, as shown at 1716a and 1716b in FIG. 17, or could be constructed without any such aerodynamic stabilizing surface.

FIG. 19 illustrates a vehicle 1930 also including a fuselage 1931 of a very simple construction having a forward mounting structure 1931a for mounting the forward lift-producing propeller 1932a, and a rear mounting structure 1931b for mounting the rear lift-producing propeller 1932b. Both propellers are unducted, i.e., free, propellers. Fuselage 1931 is formed centrally thereof with a pilots compartment 1933 and carries the two payload bays 1934a, 1934b on its opposite sides laterally of the pilot's compartment.

Vehicle 1930 illustrated in FIG. 19 also includes a front landing gear 1935a and a rear landing gear 1935b, but for simplification purposes, it does not include an aerodynamic stabilizing surface corresponding to vertical stabilizers 1716a, 1716b in FIG. 17.

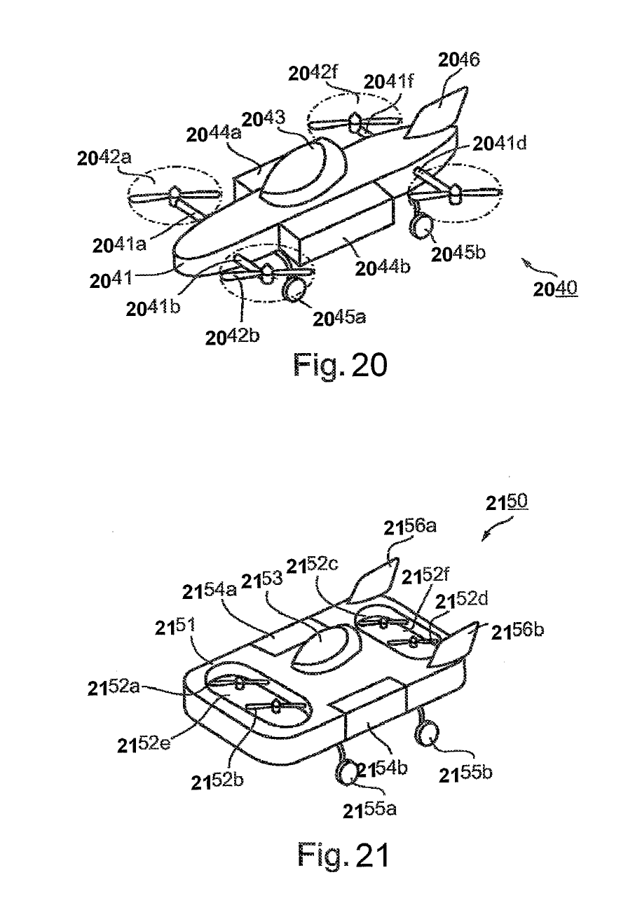

FIG. 20 illustrates a vehicle, generally designated 2040, of a similar construction as in FIG. 18 but including a fuselage 2041 mounting a pair of unducted propellers 2042a, 2042b at its front end, and a pair of unducted propellers 2042c, 2042d at its rear end by means of mounting structures 2041a-2041d, respectively. Vehicle 2040 further includes a pilot's compartment 2043 centrally of the fuselage, a pair of payload bays 2044a, 2044b laterally of the pilot's compartment, a front landing gear 2045a, a rear landing gear 2045b, and a vertical stabilizer 2046 at the rear end of the fuselage 2041 in alignment with its longitudinal axis.

FIG. 21 illustrates a vehicle, generally designated 2150, including a fuselage 2151 mounting a pair of lift-producing propellers 2152a, 2152b at its front end, and another pair 2152c, 2152d at its rear end. Each pair of lift-producing propellers 2152a, 2152b and 2152c, 2152d is enclosed within a common oval-shaped duct 2152e, 2152f at the respective end of the fuselage.

Vehicle 2150 illustrated in FIG. 21 further includes a pilot' compartment 2153 formed centrally of the fuselage 2151, a pair of payload bays 2154a, 2154b laterally of the pilot's compartment 2153, a front landing gear 2155a, a rear landing gear 2155b, and vertical stabilizers 2156a, 2156b carried at the rear end of the fuselage 2151.

FIGS. 22a, 22b and 22c are side, top and rear views, respectively, of another vehicle constructed in accordance with the present invention. The vehicle illustrated in FIGS. 22a-22c, therein generally designated 2260, also includes a fuselage 2261 mounting a lift-producing propeller 2262a, 2262b at its front and rear ends, respectively. The latter propellers are preferably ducted units as in FIG. 17.

Vehicle 2260 further includes a pilot's compartment 2263 centrally of the fuselage 2261, a pair of payload bays 2264a, 2264b laterally of the fuselage and of the pilot's compartment, a front landing gear 2265a, a rear landing gear 2265b, and a stabilizer, which, in this case, is a horizontal stabilizer 2266 extending across the rear end of the fuselage 2261.

Vehicle 2260 illustrated in FIGS. 22a-22c further includes a pair of pusher propellers 2267a, 2267b, mounted at the rear end of the fuselage 2261 at the opposite ends of the horizontal stabilizer 2266. As shown particularly in FIG. 22c the rear end of the fuselage 2261 is formed with a pair of pylons 2261a, 2261b, for mounting the two pusher propellers 2267a, 2267b, together with the horizontal stabilizer 2266.

The two pusher propellers 2267a, 2267b are preferably variable-pitch propellers enabling the vehicle to attain higher horizontal speeds. The horizontal stabilizer 2266 is used to trim the vehicle's pitching moment caused by the ducted fans 2262a, 2262b, thereby enabling the vehicle to remain horizontal during high speed flight.

Each of the pusher propellers 2267a, 2267b is driven by an engine enclosed within the respective pylori 2261a, 2261b. The two engines are preferably turbo-shaft engines. Each pylori is thus formed with an air inlet 2268a, 2268b at the forward end of the respective pylori, and with an air outlet (not shown) at the rear end of the respective pylori.

FIG. 23 schematically illustrates the drive within the vehicle 2360 for driving the two ducted fans 2362a, 2362b as well as the pusher propellers 2367a, 2367b. The drive system, generally designated 2370, includes two engines 2371, 2371b, each incorporated in an engine compartment within one of the two pylons 2361a, 2361b. Each engine 2371a, 2371b, is coupled by an over-running clutch 2372a, 2372b, to a gear box 2373a, 2373b coupled on one side to the respective thrust propeller 2367a, 2367b, and on the opposite side to a transmission for coupling to the two ducted fans 2362a, 2362b at the opposite ends of the fuselage. Thus, as schematically shown in FIG. 23, the latter transmission includes additional gear boxes 2374a, 2374b coupled to rear gear box 2375b for driving the rear ducted fan 2362b, and front gear box 2375a for driving the front ducted fan 2362b.

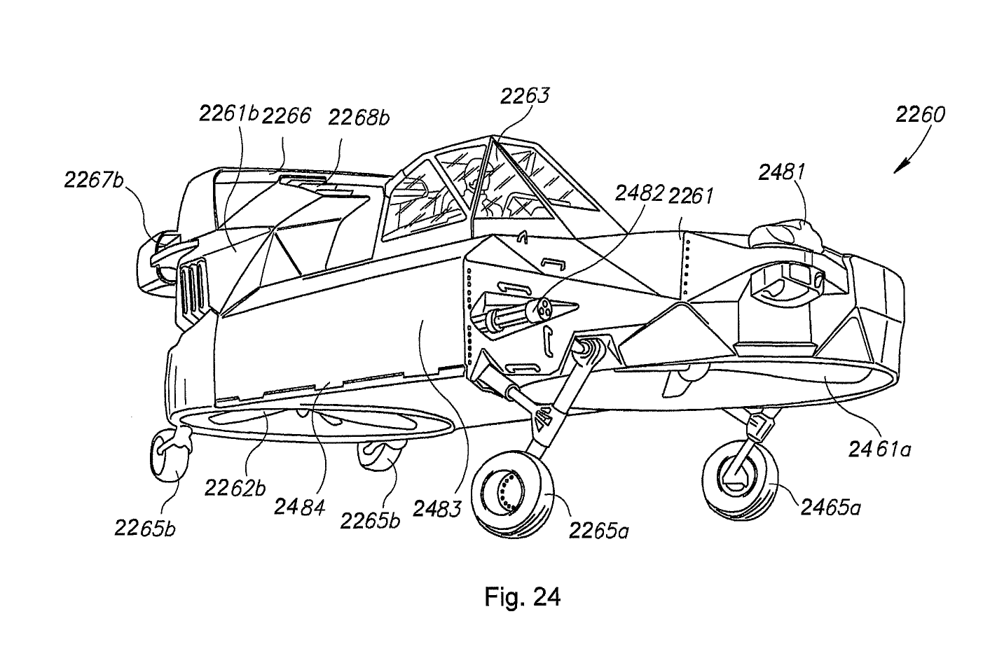

FIG. 24 pictorially illustrates an example of the outer appearance that vehicle 2360 may take.

In the pictorial illustration of FIG. 24, those parts of the vehicle which correspond to the above-described parts in FIGS. 22a-22c are identified by the same reference numeral suffixes in order to facilitate understanding. FIG. 24, however, illustrates a number of additional features which may be provided in such a vehicle.

Thus, as shown in FIG. 24, the front end of the fuselage 2261 may be provided with a stabilized sight and FLIR (Forward Looking Infra-Red) unit, as shown at 2481, and with a gun at the forward end of each payload bay, as shown at 2482. In addition, each payload bay may include a cover 2483 deployable to an open position providing access to the payload bay, and to a closed position covering the payload bay with respect to the fuselage 2261.

In FIG. 24, cover 2483 of each payload bay is pivotally mounted to the fuselage 2261 along an axis 2484 parallel to the longitudinal axis of the fuselage at the bottom of the respective bay. The cover 2483, when in its closed condition, conforms to the outer surface of the fuselage 2261 and is flush therewith. When the cover 2483 is pivoted to its open position, it serves as a support for supporting the payload, or a part thereof, in the respective payload bay.

The latter feature is more particularly shown in FIGS. 25a-25d which illustrate various task capabilities of the vehicle as particularly enabled by the pivotal covers 2583 for the two payload bays. Thus, FIG. 25a illustrates the payload bays used for mounting or transporting guns or ammunition 2585a; FIG. 25b illustrates the use of the payload bays for transporting personnel or troops 2585b; FIG. 25c illustrates the use of the payload bays for transporting cargo 2585c; and FIG. 25d illustrates the use of the payload bays for evacuating wounded 2585d. Many other task or mission capabilities will be apparent.

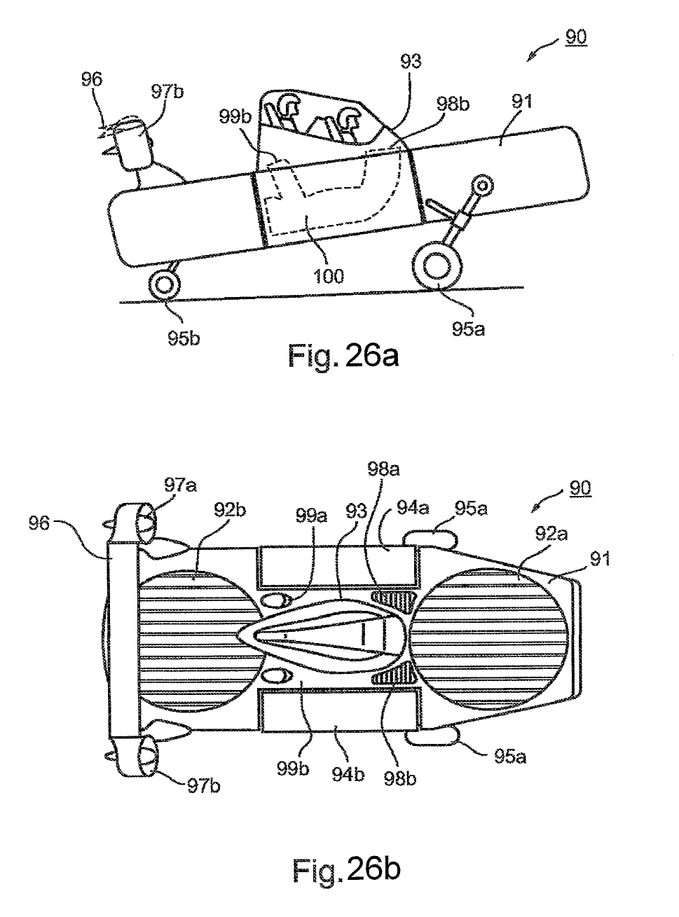

FIGS. 26a and 26b are side and top views, respectively, illustrating another vehicle, generally designated 90, of a slightly modified construction from vehicle 2260 described above. Thus, vehicle 90 illustrated in FIGS. 26a and 26b also includes a fuselage 91, a pair of ducted-fan type lift-producing propellers 92a, 92b at the opposite ends of the fuselage, a pilot's compartment 93 centrally of the fuselage, and a pair of payload bays 94a, 94b laterally of the pilot's compartment 93. Vehicle 90 further includes a front landing gear 95a, a rear landing gear 95b, a horizontal stabilizer 96, and a pair of pusher propellers 97a, 97b, at the rear end of fuselage 91.

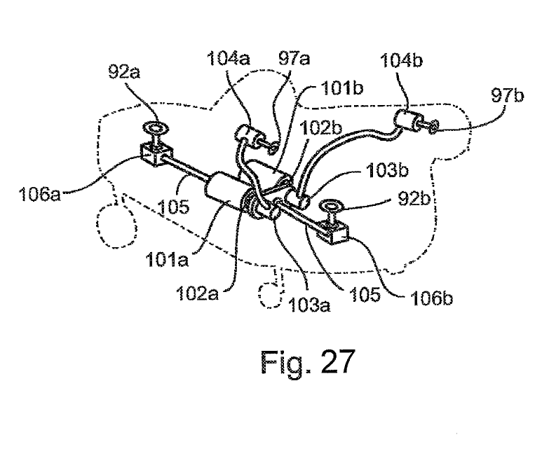

FIG. 27 schematically illustrates the drive system in vehicle 90. Thus as shown in FIG. 27, vehicle 90 also includes two engines 101a, 101b for driving the two ducted fans 92a, 92b and the two pusher propellers 97a, 97b, respectively, as in vehicle 2260. However, whereas in vehicle 2260 the two engines are located in separate engine compartments in the two pylons 2261a, 2261b, in vehicle 90 illustrated in FIGS. 26a and 26b both engines are incorporated in a common engine compartment, schematically shown at 100 in FIG. 26a, underlying the pilot's compartment 93. The two engines 101a, 101b (FIG. 27), may also be turbo-shaft engines as in FIG. 23. For this purpose, the central portion of the fuselage 91 is formed with a pair of air inlet openings 98a, 98b forward of the pilot's compartment 93, and with a pair of air outlet openings 99a, 99b rearwardly of the pilot's compartment.

As shown in FIG. 27, the two engines 101a, 101b drive, via the over-running clutches 102a, 102b, a pair of hydraulic pumps 103a, 103b which, in turn, drive the drives 104a, 104b of the two pusher propellers 97a, 97b. The two engines 101a, 101b are further coupled to a drive shaft 105 which drives the drives 106a, 106b of the two ducted fans 92a, 92b, respectively.

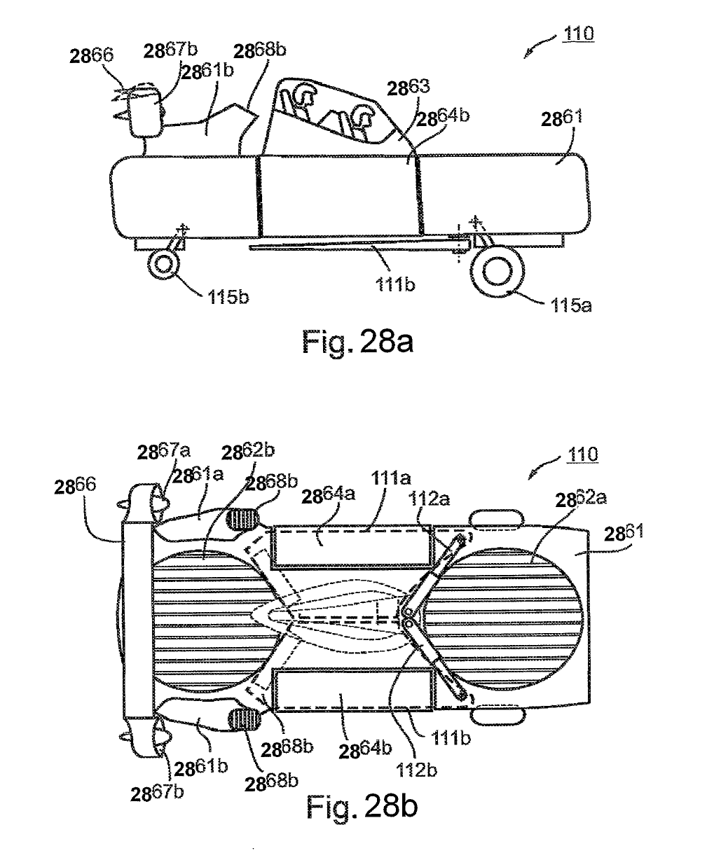

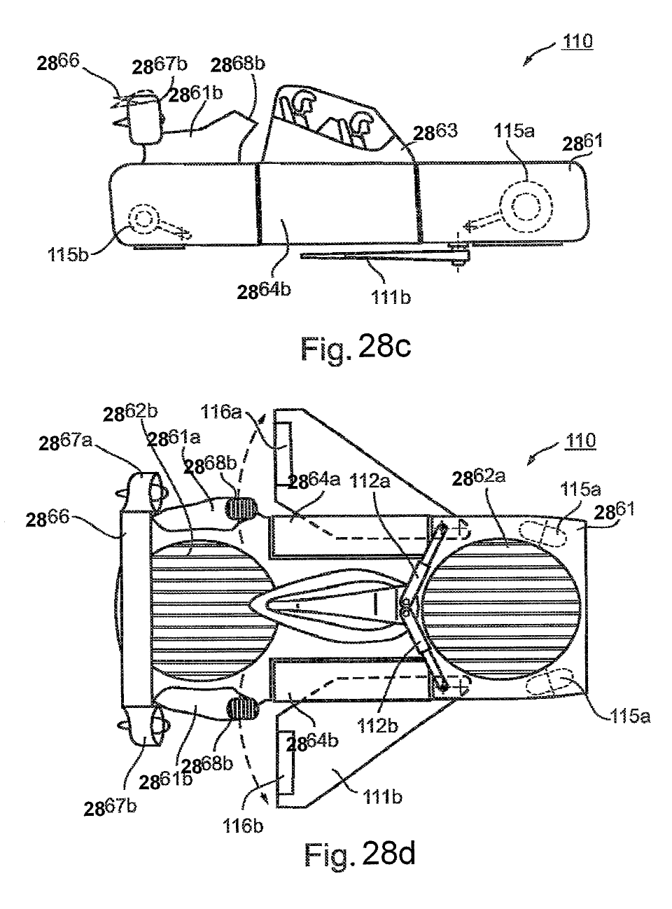

FIGS. 28a-28d illustrate another vehicle, therein generally designated 110, which is basically of the same construction as vehicle 2260 described above with respect to FIGS. 22a-22c, 23, 24 and 25a-25d; to facilitate understanding, corresponding elements are therefore identified by the same reference numeral suffixes. Vehicle 110 illustrated in FIGS. 28a-28d, however, is equipped with two stub wings, generally designated 111a, 111b, each pivotally mounted to the fuselage 2861, under one of the payload bays 2864a, 2864b, to a retracted position shown in FIGS. 28a and 28b, or to an extended deployed position shown in FIGS. 28c and 28d for enhancing the lift produced by the ducted fans 2262a, 2262b. Each of the stub wings 111a, 111b is actuated by an actuator 112a, 112b driven by a hydraulic or electrical motor (not shown). Thus, at low speed flight, the stub wings 111a, 111b, would be pivoted to their stowed positions as shown in FIGS. 28a and 28b; but at high speed flight, they could be pivoted to their extended or deployed positions, as shown in FIGS. 28c and 28d, to enhance the lift produced by the ducted fans 2861a, 2861b. Consequently, the blades in the ducted fans would be at low pitch producing only a part of the total lift force.

The front and rear landing gear, shown at 115a and 115b, could also by pivoted to a stowed position to enable higher speed flight, as shown in FIGS. 28c and 28d. In such case, the front end of the fuselage 2861 would preferably be enlarged to accommodate the landing gear when in its retracted condition. Vehicle 110 illustrated in FIGS. 28a-28d may also include ailerons, as shown at 116a, 116b (FIG. 28d) for roll control.

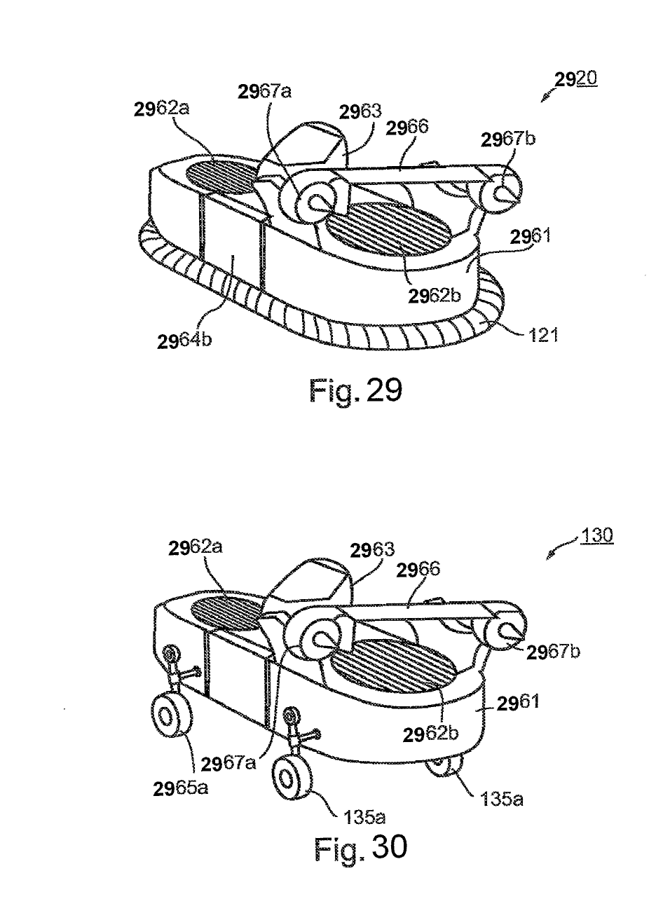

FIG. 29 illustrates how the vehicle, such as vehicle 2260 illustrated in FIGS. 22a-22d, may be converted to a hovercraft for traveling over ground or water. Thus, the vehicle illustrated in FIG. 29, and therein generally designated 2920, is basically of the same construction as described above with respect to FIGS. 22a-22d, and therefore corresponding parts have been identified with the same reference numeral suffixes. In vehicle 2920 illustrated in FIG. 29, however, the landing gear wheels (65a, 2965b, FIGS. 22a-22d) have been removed, folded, or otherwise stowed, and instead, a skirt 121 has been applied around the lower end of the fuselage 2961. The ducted fans 2962a, 2962b, may be operated at very low power to create enough pressure to cause the vehicle to hover over the ground or water as in hovercraft vehicles. The variable pitch pusher propellers 2967a, 2967b would provide forward or rear movement, as well as steering control, by individually varying the pitch, as desired, of each propeller.

Vehicles constructed in accordance with the present invention may also be used for movement on the ground. Thus, the front and rear wheels of the landing gears can be driven by electric or hydraulic motors included within the vehicle.

FIG. 30 illustrates how such a vehicle can also be used as an ATV (all terrain vehicle). The vehicle illustrated in FIG. 30, therein generally designated 130, is basically of the same construction as vehicle 2260 illustrated in FIGS. 22a-22d, and therefore corresponding parts have been identified by the same reference numeral suffixes to facilitate understanding. In vehicle 130 illustrated in FIG. 30, however, the two rear wheels of the vehicle are replaced by two (or four) larger ones, bringing the total number of wheels per vehicle to four (or six). Thus, as shown in FIG. 30, the front wheels (e.g., 2965a, FIG. 22c) of the front landing gear are retained, but the rear wheels are replaced by two larger wheels 135a (or by an additional pair of wheels, not shown), to enable the vehicle to traverse all types of terrain.

When the vehicle is used as an ATV as shown in FIG. 30, the front wheels 2965a or rear wheels would provide steering, while the pusher propellers 2967a, 2967b and main lift fans 2962a, 2962b would be disconnected but could still be powered-up for take-off if so desired. The same applies also with respect to the hovercraft version illustrated in FIG. 29.

It will thus be seen that the invention thus provides a utility vehicle of a relatively simple structure which is capable of performing a wide variety of VTOL functions, as well as many other tasks and missions, with minimum changes in the vehicle to convert it from one task or mission to another.

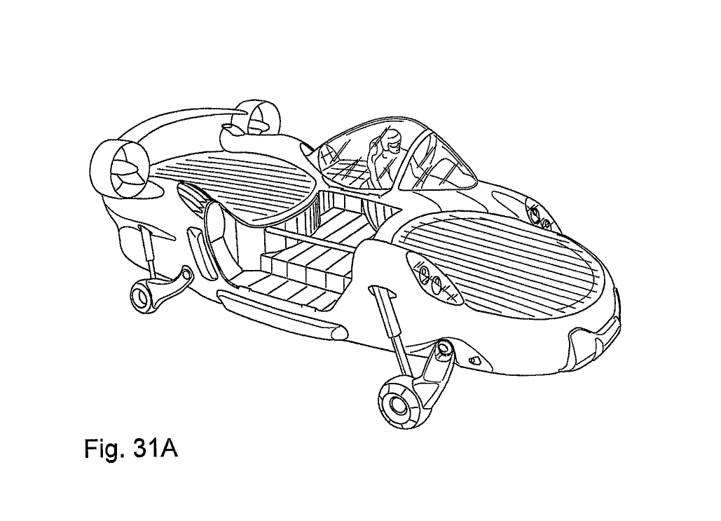

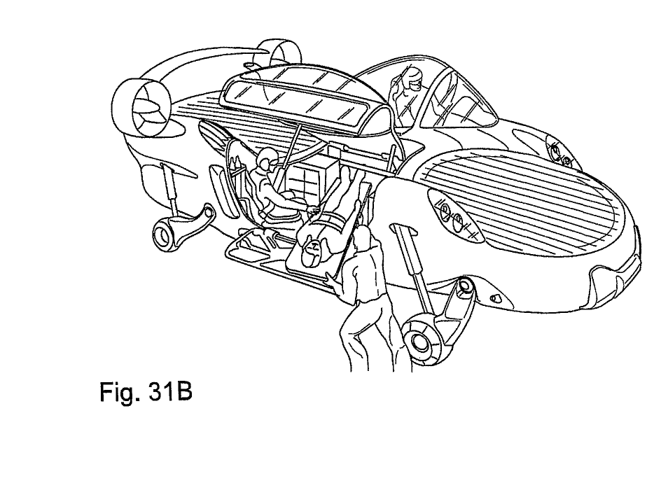

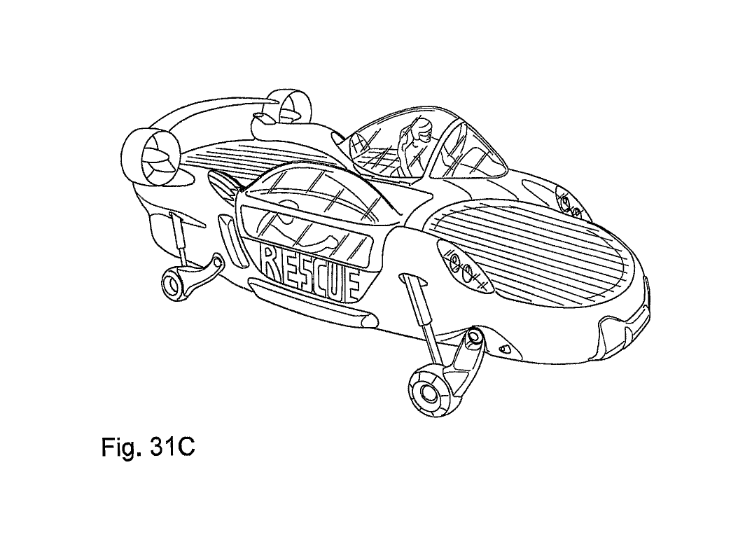

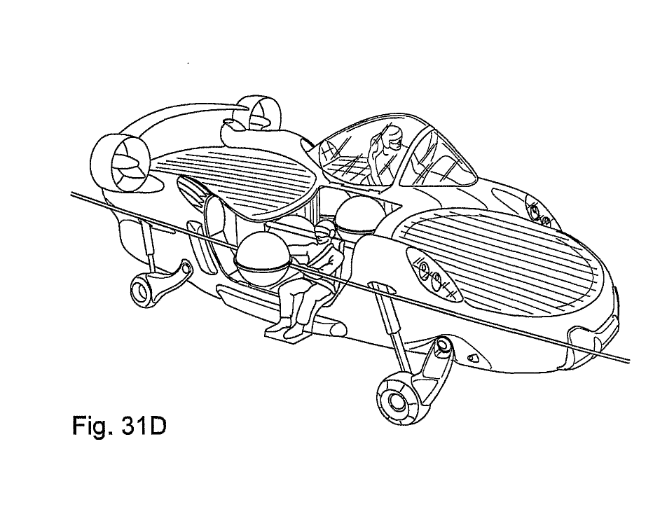

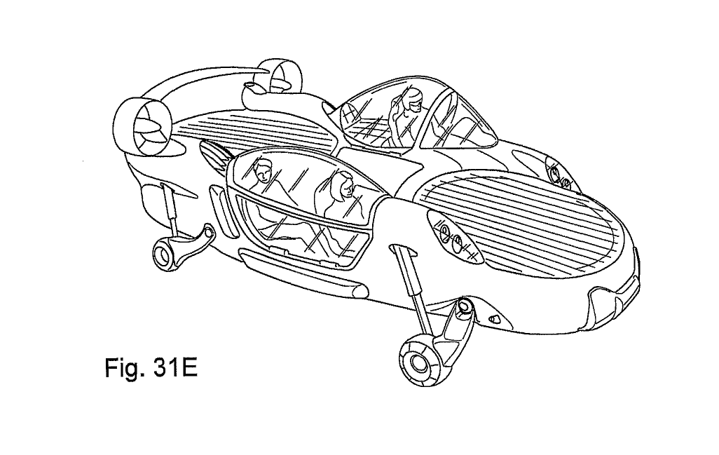

FIGS. 31a-31e are pictorial illustrations of alternative vehicle arrangements where the vehicle is relatively small in size, having the pilot's cockpit installed to one side of the vehicle. Various alternative payload possibilities are shown.

FIG. 31a shows the vehicle in its basic form, with no specific payload installed. The overall design and placement of parts of the vehicle are similar to those of the ‘larger’ vehicle described in FIG. 24. with the exception of the pilot's cockpit, which in the arrangement of FIG. 31a takes up the space of one of the payload bays created by the configuration shown in FIG. 24. The cockpit arrangement of FIG. 31a frees up the area taken up by the cockpit in the arrangement of FIG. 8 for use as an alternative payload area, increasing the total volume available for payload on the opposite side of the cockpit. It is appreciated that the mechanical arrangement of engines, drive shafts and gearboxes for the vehicle of FIG. 31a may be that described with reference to FIG. 23.

FIG. 31b illustrates how the basic vehicle of FIG. 31a may be used to evacuate a patient. The single payload bay is optionally provided with a cover and side door which protect the occupants, and which may include transparent areas to enable light to enter. The patient lies on a stretcher which is oriented predominantly perpendicular to the longitudinal axis of the vehicle, and optionally at a slight angle to enable the feet of the patient to clear the pilot's seat area and be moved fully into the vehicle despite its small size. Space for a medical attendant is provided, close to the outer side of the vehicle.

FIG. 31c shows the vehicle of FIG. 31b with the cover and side door closed for flight.

FIG. 31d illustrates how the basic vehicle of FIG. 31a may be used to perform various utility operations such as electric power-line maintenance. In the example shown if FIG. 31d, a seat is provided for an operator, facing outwards towards an electric power-line. For illustration purposes, the operator is shown attaching plastic spheres to the line using tools. Uninstalled sphere halves and additional equipment may be carried in the open space behind the operator. Similar applications may include other utility equipment, such as for bridge inspection and maintenance, antenna repair, window cleaning, and other applications. One very important mission that the utility version of FIG. 31d could perform is the extraction of survivors from hi-rise buildings, with the operator assisting the survivors to climb onto the platform while the vehicle hovers within reach.

FIG. 31e illustrates how the basic vehicle of FIG. 31a may be used to carry personnel in a comfortable closed cabin, such as for commuting, observation, performing police duties, or any other purpose.

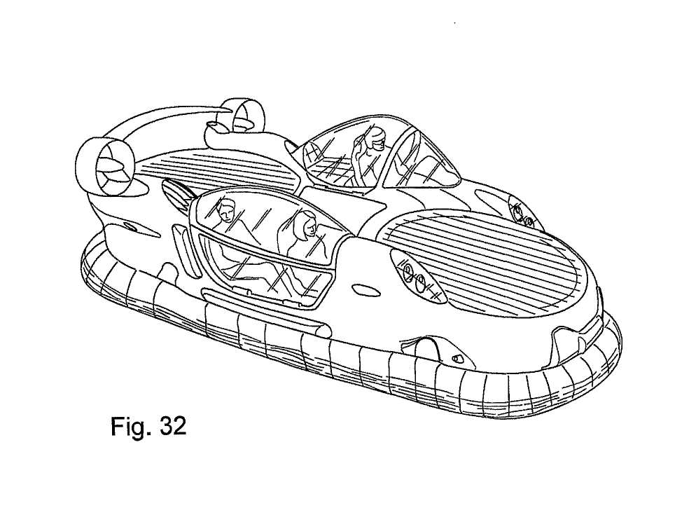

FIG. 32 is a pictorial illustration of a vehicle constructed typically in accordance with the configuration in FIG. 31 but equipped with a lower, flexible skirt for converting the vehicle to a hovercraft for movement over ground or water. While the vehicle shown in FIG. 32 is similar to the application of FIG. 31e, it should be mentioned that a skirt can be installed on any of the applications shown in FIG. 31.

While FIGS. 31a-32 show a vehicle having a cockpit on the left hand side and a payload bay to the right hand side, it is appreciated that alternative arrangements are possible, such as where the cockpit is on the right hand side and the payload bay is on the left hand side. All the descriptions provided in FIGS. 31a-32 apply also to such an alternative configuration.

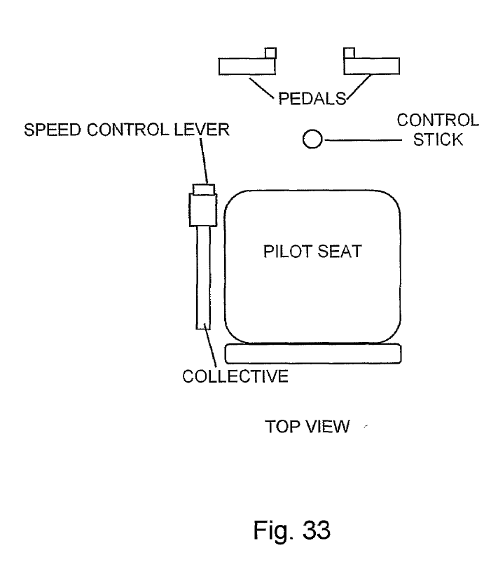

FIG. 33 shows a cockpit control configuration that may be used in any of the various vehicle configurations of the present invention described herein.

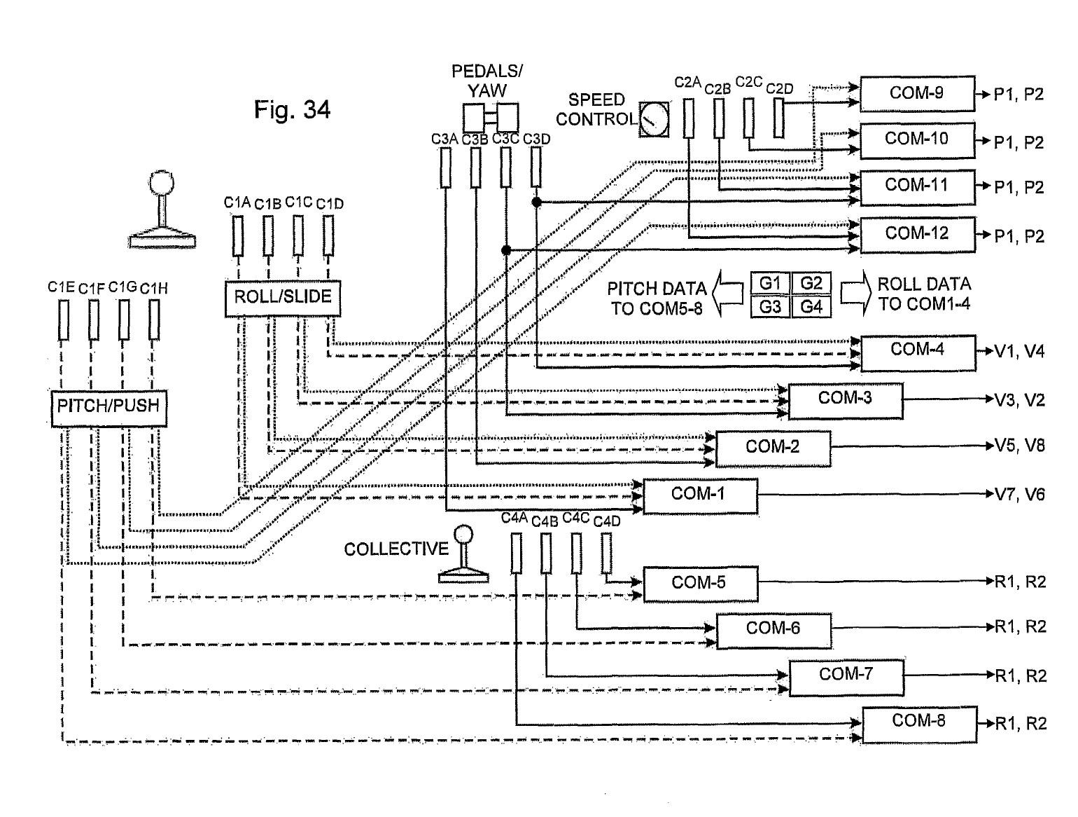

Reference is now made to FIG. 34, which is a simplified block diagram of a multi-channel flight control system, constructed and operative in accordance with a preferred embodiment of the present invention. The various vane-controlled vehicle configurations of the present invention are preferably equipped with the multi-channel flight control system of FIG. 34, or portions thereof as applicable, although it is appreciated that aspects of the system of FIG. 34 that do not relate to vane control may be applied to non-vane-controlled vehicles. The flight control system of the present invention is designed in a manner that will ensure the safety of the vehicle in event of a malfunction in any one of its channels and enable the flight to continue down to a safe landing. In order to facilitate this feature, the system is configured as a Fly-By-Wire system, separated into channels, with each having its own cockpit controls sensors, computer, actuator and control surfaces or variable pitch rotor/propeller blades where applicable. Each vehicle control function preferably has a control power reserve that enables the vehicle to be adequately controllable even if some control power is lost due to malfunction or a runaway condition in one of its channels. Separate vehicle position, rate and acceleration sensors together with altitude and airspeed data sensors are used to generate data on the vehicle's flight state.

It will be appreciated that the number of sensors, computers and channels shown in FIG. 34 may vary, provided that each of the vehicle's axes is provided multiple control paths such that loss of any given control path, while resulting in the path's controlled element being unable to perform its function, does not influence the remaining paths/channels on the same axis from continuing to perform their duties as required.

As can be seen in FIG. 34, the control system is divided into three main groups of controls:
Control of the blades pitch angle on both main lift rotors;
Control of all aerodynamic vanes installed on the vehicle in the entrance plane as well as the exit plane of both main lift rotors; and
Control of the blades pitch angle on both aft mounted pusher propellers, such as may be particularly seen in FIGS. 31a-31e.

Each group of controls features four separate channels/paths which include 4 cockpit controls position sensors (e.g. potentiometers, LVDTs, RVDTs), 4 control computers, and 4 actuators, each powering ¼ of the control mechanisms (such as vanes) installed on the vehicle. In the case of actuators for rotor/propeller blade pitch change, each actuator will have four separate movement channels, each responsible for ¼ of the total movement available for full control of said rotor or propeller.

The various control paths are shown in FIG. 34 by lines ending with arrows. Solid lines represent control paths that are constant throughout the flight envelope. Dashed lines represent paths that operate at high speed (cruise) flight, and dotted lines represent paths that are active during hover and Low Speed Maneuver (LSM) flight.

Logical switching, or, alternatively, continuous gain scheduling, is used to transition between LSM to cruise and vice versa. These switching modules are shown as rectangles marked as S1, S2.

Also shown in FIG. 34 are:

| | |
|---|---|
| COM1-COM12 | Flight control computers |
| P1, P2 | Pusher propellers |
| R1, R2 | Main lift rotors |
| V1-V8 | 8 segments of control vanes |
| C1-C4; a-h | Controls position sensors |
| G1-G4 | Four vehicle inertial position, rate and acceleration, |
| | altitude and airspeed sensors. Additional sensors such as, |
| | but not limited to, GPS, radar altimeters, millimeter wave |
| | radars may be added. |

Operation of the control system of FIG. 34 is now described with respect to the main lift rotors. Control of the pitch of the blades on both main lift rotors is accomplished by four separate computers (nos. 5-8). Each computer reads independently the position of the collective control, as well as the longitudinal stick position. Each computer also reads information on the vehicle's inertial position, rate and acceleration, altitude and airspeed from one of the four inertial position, rate and acceleration, altitude and airspeed sensors installed in the vehicle. Each computer commands ¼ of the available travel of each of the two blade pitch change actuators connected to the main lift rotors. When the vehicle is in LSM mode, the information on the longitudinal stick position does not come into play in the main lift rotors control system. As the vehicle's motion becomes more “cruise” oriented, and less “LSM” oriented, each of the four computers, operating separately from each other, will switch or modify the gain associated with the reading on the position sensors attached to the pilot's controls in order to obtain the desired effect on the rotors. The software governing the operation of each computer, and especially the gain scheduling associated with the mode transitions in flight, may employ conventional techniques, or may be based on Fuzzy Logic/Neural computation methods.

Due to the above arrangement, a failure of one channel of the four will merely result in the main lift rotors not being able to change their blade pitch angles through more than ¾ of their overall range. It will be appreciated that in event of a runaway malfunction, half of the normal travel will still be available. It will be further appreciated by analyzing the overall behavior of the vehicle that sufficient control is still available for carrying out a controlled descent to a landing.

Operation of the control system of FIG. 34 is now described with respect to control of the vehicle's aerodynamic vane surfaces. In an exemplary configuration a vehicle has 300 vanes powered by 8 separate actuators in a manner similar to that which is required for rotor blade pitch change. However, here each actuator moves its own set of vanes through the total useful range of movement of the vanes, such as 10 degrees to each side and as dictated by aerodynamic considerations.

Operation of the control system of FIG. 34 is now described with respect to control of the vehicle's pusher propellers. Control of the vehicles pusher propellers is similar to that of the main lift rotors. However, it will be appreciated that since the pusher propellers are not critical to the controllability of the vehicle and its ability to perform a safe landing, the redundancy provided to the pusher propellers may be reduced, such as to two control channels instead of the four-channel arrangement shown for the other control groups.

Operation of the control system of FIG. 34 is now described with respect to control of the vehicle's inertial and other sensors. In the system of FIG. 34, four separate inertial position, rate and acceleration, altitude and airspeed sensors are installed. However, any of the control channels may share data generated on common sensor units. Thus, any error or malfunction of one sensor inside one of the four sensor packages may affect all three groups of controls: main rotors, vanes and pusher propellers. The design of the vehicle should be sufficiently robust enough so that any “crippling” of all modes of control, while not causing a hazardous situation with any of the controls separately, will still not pose a threat to the vehicle's safety when, as a result of one sensor malfunction, all three control groups are crippled or weakened simultaneously. Alternatively, additional sensor packages or individual sensors may be added as desired.

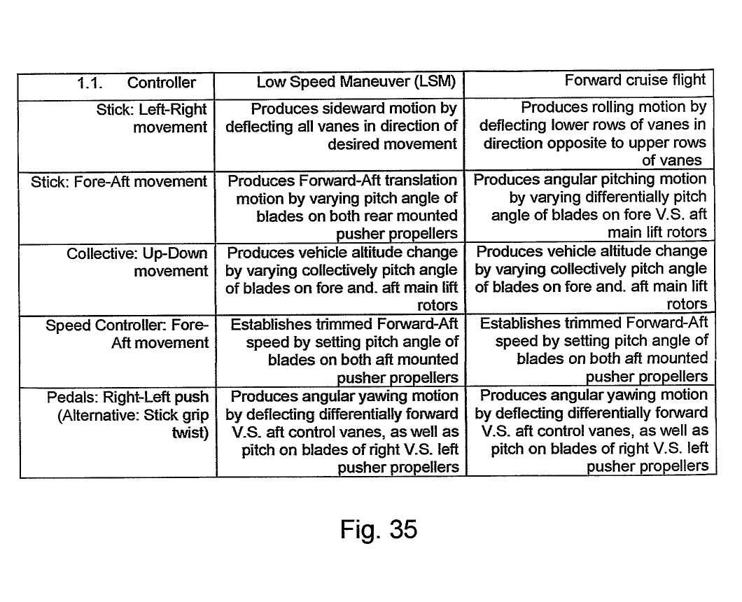

FIG. 35 shows a table summarizing the effect that each control has on the vehicle in two different flight conditions: hover and LSM (Low Speed Maneuver), and normal cruise flight.

It is appreciated that the various control surfaces may be divided into more or fewer sections than the four sections shown in FIG. 34, each independently controlled by a separate control path. It is also appreciated that each computer may control more than one control path of the vehicle, provided that each control path relates to a different type of vehicle control, such as pitch and yaw.

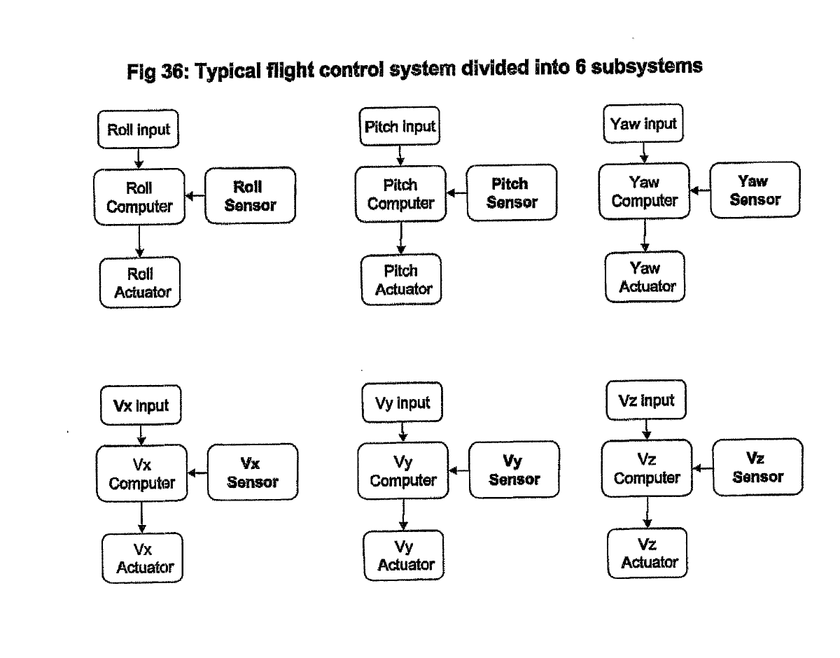

Reference is now made to FIGS. 36-40, which is an alternative flight control system arrangement, constructed an operative in accordance with a preferred embodiment of the present invention. A typical control system includes 3 elementary parts: input, output and feedback. In a flight control system the inputs are typically the pilot grips (including all pilot controls such as pedals collective etc.), the outputs are typically the various actuators in the vehicle and feedback is typically provided by sensors that measure the inertial parameters of the vehicle. Typically, each FCS outputs, controls one of the vehicle's 6 degrees of freedom (DOF). FIG. 36 illustrates a typical FCS with 6 control subsystems, each corresponding to one DOF and having an input, sensor, computer and actuator.

The FCS may control the vehicle in all 6 DOF (i.e. 3 angular velocities and 3 linear velocities) but need not be limited to this number of control parameters (i.e. speed control, altitude control may be also controlled by the FCS).

The control system architecture of the current invention is designed in a manner that will ensure a safe landing of the vehicle in the event of malfunction of any individual (i.e. first malfunction of any part of the FCS system) part of the FCS. In order to facilitate this feature each input and output control element is divided into more than one section, each having either equal or unequal control power (CP).

In the current invention, each control element of the FCS is divided into 4 equal sections having equal CP. The description herein assumes this number of sections but it is not limited to 4 or any other number of sections.

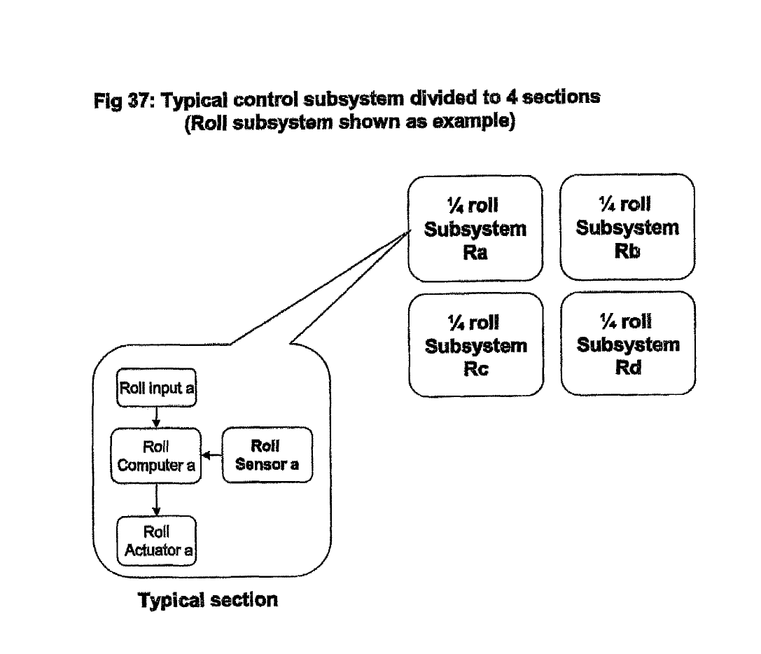

FIG. 37 illustrates one control subsystem. There are 4 independent input Potentiometers (or RVDT, LVDT or any other measuring devise) that read the pilot command, 4 actuators, each one controlling part of the total control power (CP) of this subsystem, and 4 sensors, each one measuring the physical parameter, such as roll pitch and yaw rate and X Y and Z velocities, for feedback. The sum of the CP of all the sections is higher than the CP required for safe landing.

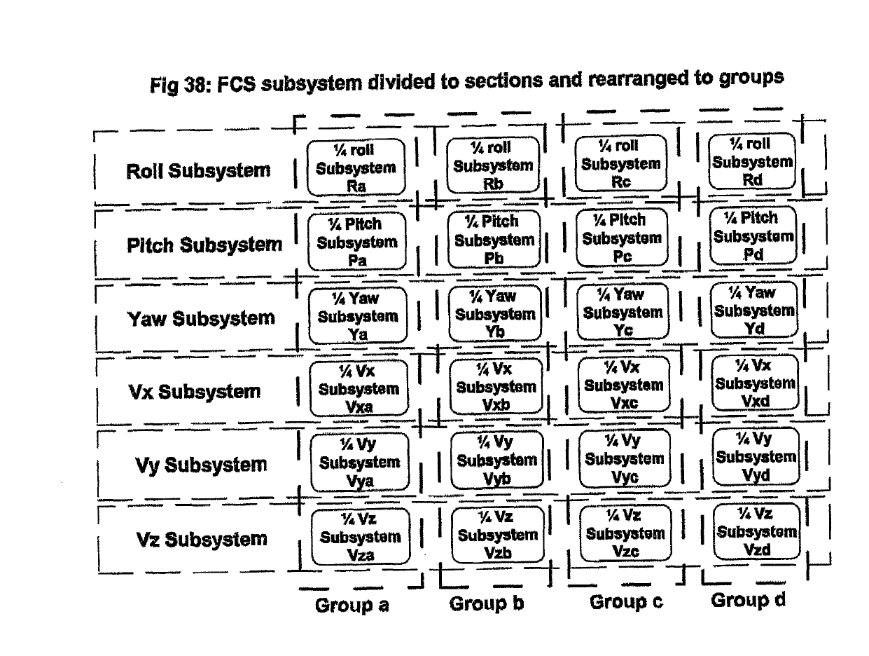

FIG. 38 illustrates the grouping method: The control subsystems are grouped into 4 groups according to the following rules:
1. In each group there are at least 2 different subsystems that partially control two different DOF's
2. These subsystem may share a computer to compute the control rules
3. Each group is characterized by having one or more points where a failure (i.e. the computer, sensor pack etc.) will cause the entire group to fail.
4. Each group operates independently from the other groups.

Note: information may be shared between groups if desired.

A single point of failure is defined as a failure that will shut down the entire group.

The FCS subsystem sections are grouped in a manner that in one group there is one section from each subsystem.

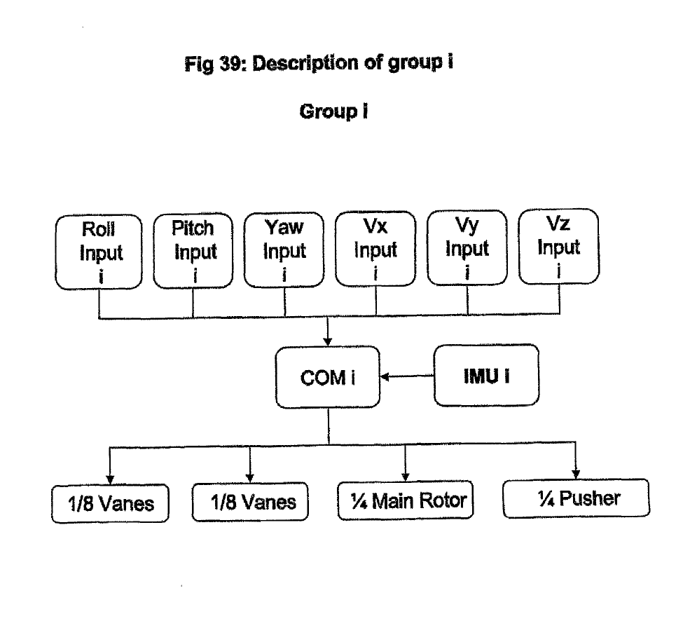

FIG. 39 illustrates a typical group. The single point of failure is the computer and the IMU sensor. The group has 6 inputs from the pilot grips. The IMU block represents a collection of sensors that supply the feedback path to the subsystems. These sensors may measure inertial or non-inertial parameters or any other physical parameters that are required for the control system. Control system that control a physical parameter require a feedback channel that measures the controlled parameter and compare it to the desired one. This is called a feedback path. For example if you need to control the roll rate you measure the current roll rate, compare it to the desired one and give command to the actuator. The IMU may be packed in a single package that transfers the information in a single transmission path (becoming a single point of failure) or it may be a collection of separate sensors that transfer the information in multiple transmission paths (and not being a single point of failure). The control loop calculation is performed by the computer and the output is forwarded to 4 actuators, each one controlling a different subsystem. In the current example there are only 4 outputs that control all 6 DOF since the two ⅛ vanes outputs control the roll and Vy, as will be explained later.

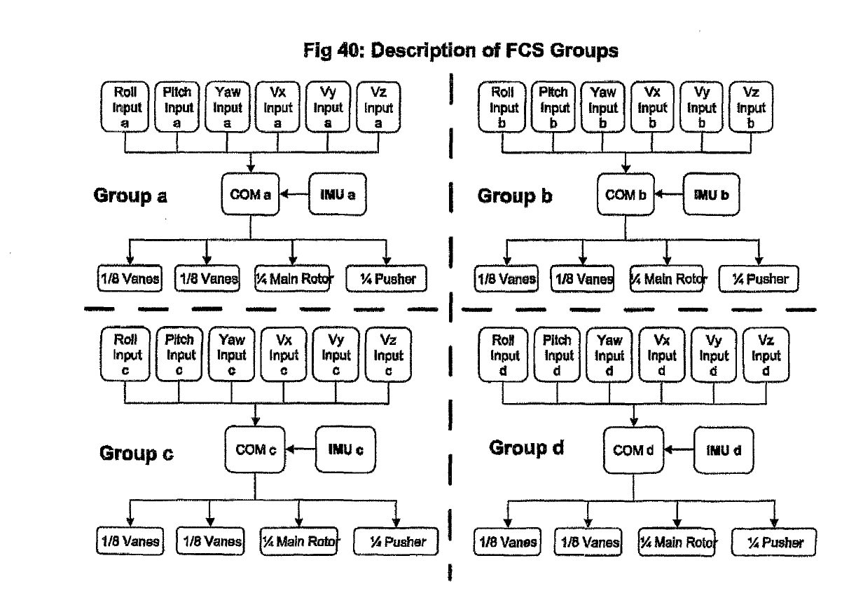

FIG. 40 illustrates the FCS groups in the current vehicle. The FCS is divided into 4 independent groups, each group controlling ¼ of the total CP of the vehicle. Each group has its own inputs from the pilot grips, inputs from the IMU and a computer that generates the output for the actuators.

The failure sequence description of the current invention is as follows: A malfunction in a group can cause a partial or total malfunction of that group or of any of its subsystems. In case of partial or total failure the CP of the remaining groups will be sufficient for safe landing. It should be mentioned that in a case where the overall CP is significantly higher that the CP required for safe landing, the loss of even more than one group may potentially be tolerated, depending on the configuration. Thus, for example, where CPx is the control power required for a safe landing, and n of m groups fail, as long as the CPr of the remaining m-n groups is >=CPx, the vehicle may land safely.

Operation of the control system of FIG. 40 is now described with respect to the main lift rotors. Control of the pitch of the blades on both main lift rotors may be accomplished by four separate computers in four separated groups (COM a-d). Each computer reads independently the position of the collective control, as well as the longitudinal stick position. Each computer also reads information on the vehicle's inertial position, rate and acceleration, altitude and airspeed from the inertial position, rate and acceleration, altitude and airspeed sensors connected to the said computer. Each computer commands ¼ of the available travel of the blade pitch change actuators connected to the main lift rotors.

Due to the above arrangement, a failure of one group of the four will merely result in the main lift rotors not being able to change their blade pitch angles through more than ¼ of their overall range. It will be appreciated that in event of a runaway malfunction (e.g., loss of 2 of 4 groups), half of the normal travel will still be available. It will be further appreciated by analyzing the overall behavior of the vehicle that sufficient control is still available for carrying out a controlled descent to a landing assuming CPr=CPx.

Operation of the control system of FIG. 40 is now described with respect to control of the vehicle's aerodynamic vane surfaces. In an exemplary configuration a vehicle has 400 vanes powered by 8 separate actuators in a manner similar to that which is required for rotor blade pitch change. However, here each actuator moves its own section of typically 50 vanes through the total useful range of movement of the vanes, such as 10 degrees to each side and as dictated by aerodynamic considerations. Any two sections of vanes control the vehicle in roll yaw and Vy DOF depending on the relative vane movement between these two sections. Each group controls two sections of vanes, therefore each group controls both roll yaw and Vy DOF.

Operation of the control system of FIG. 40 is now described with respect to control of the vehicle's pusher propellers. Control of the vehicles pusher propellers is similar to that of the main lift rotors. However, it will be appreciated that since the pusher propellers are not critical to the controllability of the vehicle and its ability to perform a safe landing, the redundancy provided to the pusher propellers may be reduced, such as to two control groups instead of the four-group arrangement shown for the other control groups.

Operation of the control system of FIG. 40 is now described with respect to control of the vehicle's inertial and other sensors. In the system of FIG. 40, four separate inertial position, rate and acceleration, altitude and airspeed sensors (IMU) are installed. Each IMU is connected to a different computer.

One of the main advantages of the ducted fan vehicle equipped with Vane Control System (VCS) and Thrust Fan Unit (TFU) described hereinabove is the ability to fly laterally in the opposite direction to the rolling angle or to fly laterally without rolling by applying pure side force, and/or to increase the forward speed without changing the pitch attitude by changing the thrust generated with the TFU

Conventional helicopters, in order to fly laterally, must roll to the same side the pilot wants to fly, and in order to increase the forward speed the helicopter must change the pitch attitude of the rotor disk. This inter-dependence of the helicopter's Degrees of Freedom (DOF), while limiting its maneuvering capability, reduce the pilot's workload to typically four controlled DOFs: pitch and roll of the main rotor(s) disk(s), yaw of the fuselage and vertical velocity.

In the ducted fan vehicles described hereinabove, preferably six continuous and independent DOF, (3 linear and 3 angular), can be separately controlled in real-time, offering advantages in maneuverability and agility, however the controlling of that number of DOF is typically beyond the capability of a common pilot. Therefore, in the ducted fan vehicles described hereinabove, some artificial autopilot assistance is required. In the present invention methods for applying such autopilot assistance will be illustrated.

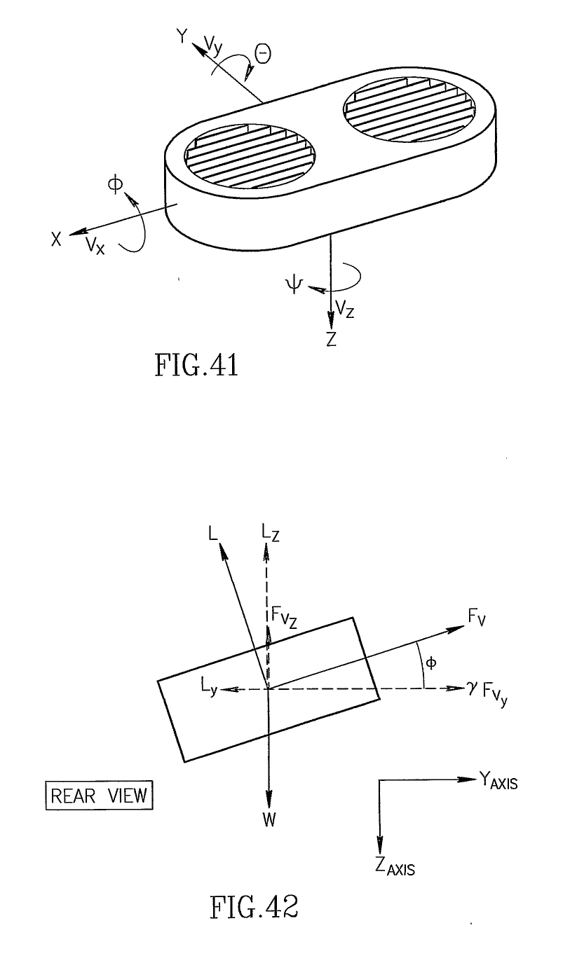

FIG. 41 illustrates the major axes X Y and Z and the linear velocities Vx Vy Vz along each axis of the ducted fan vehicle having a forward and aft ducts each with main rotors and control vanes, which may have pusher propellers also called ducted thrust fans units (TFU) or thrusters, such for example as described in FIG. 30 or FIG. 31 hereinabove. The Euler angles φ,θ,ψ as defined at each axis are also shown.

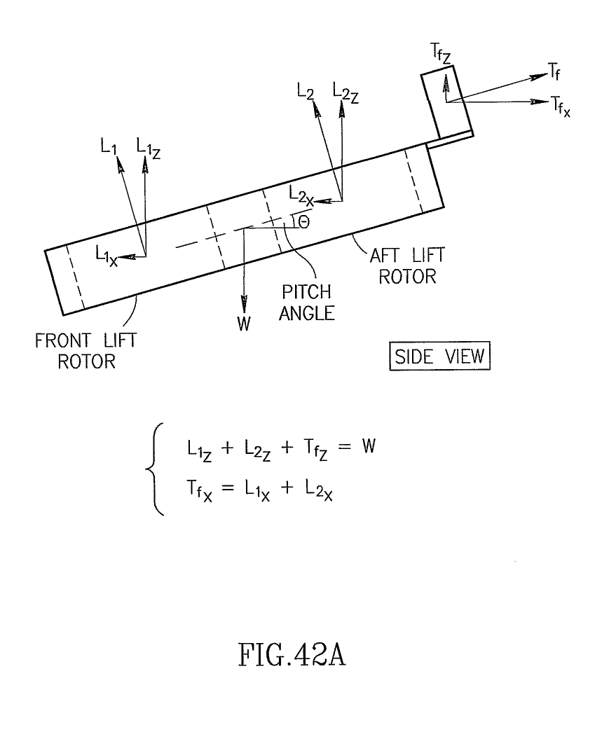

In FIG. 42 one can see a schematic rear view of the vehicle of FIG. 41. In this view, Z axis is pointing downward and Y axis is pointing to the right. The vehicle is hovering at non zero roll angle φ to the left as shown. L is the lift force produced by the lift rotors. The lift force components along the Z and Y axes are Lz and Ly respectively. In addition, Fv is the pure lateral force produced by the Vane Control System (VCS) and this force components along the axes Z and Y are Fvz and Fvy respectively. W is the vehicle weight. One can see that the vehicle can be trimmed so that the sum of Lz and Fvz will be equal to W and Fvy will be equal to Ly but at the opposite direction. In this case the sum of all forces on the vehicle Center of Gravity (CG) will be zero and the vehicle is in the state of equilibrium at a non-zero roll angle.

FIG. 42A shows a schematic side view of the vehicle in hover at non zero ‘nose-down’ pitch angle θ. The front lift fan is producing lift force L1 and the aft lift fan is producing lift force L2. The TFU is producing axial thrust Tf. One can calculate the proper settings for the lift fans collective pitch angles and the TFU pitch angles so the equilibrium will be maintained as described by the equations in FIG. 42A, and the vehicle will maintain stable hover at non zero pitch angle.

FIGS. 42 and 42A show the forces exerted when the vehicle rolls or pitches to one direction, with the same equations applying to the other direction as well. The ability to hover at non-zero roll and pitch angles is an advantageous characteristic of the ducted fan vehicle with VCS described hereinabove and is useful, for example, for takeoff and landing on inclined surfaces or on moving decks of vessels.

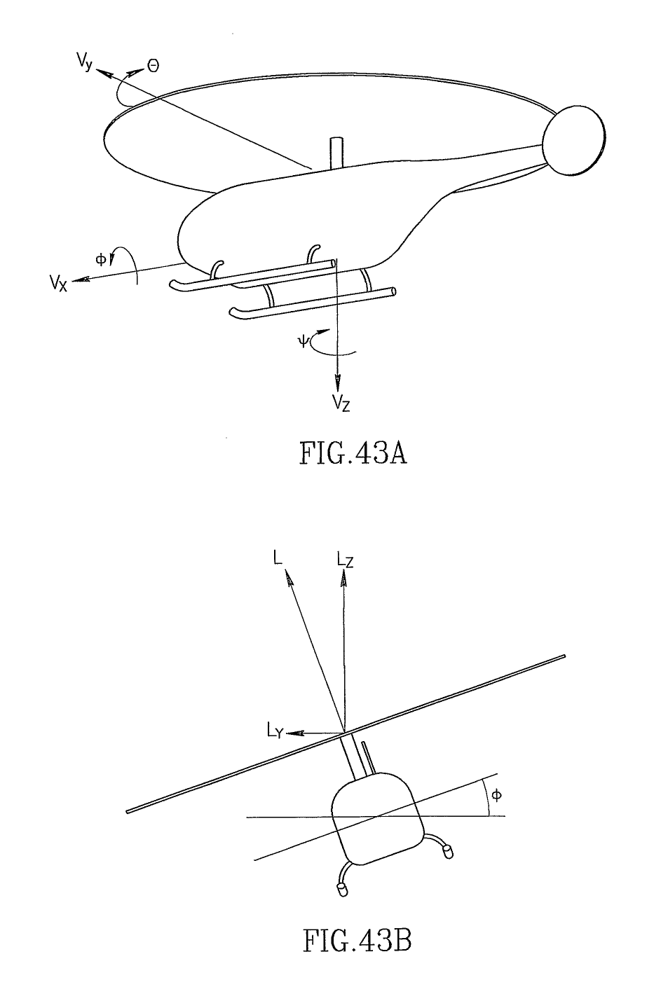

In a conventional helicopter, in order to develop lateral velocity the pilot must roll the lift rotor disc to the same side towards which he wants to move. FIG. 43A illustrates the major axes X Y and Z, the linear velocities Vx Vy Vz along each axis and the Euler angles φ, θ,ψ of a conventional helicopter. FIG. 43B shows a rear view of a helicopter rolled at angle φ around the X axis. The lift generated by its rotor produces a force component along the Y axis Fy which accelerates the vehicle to this direction.

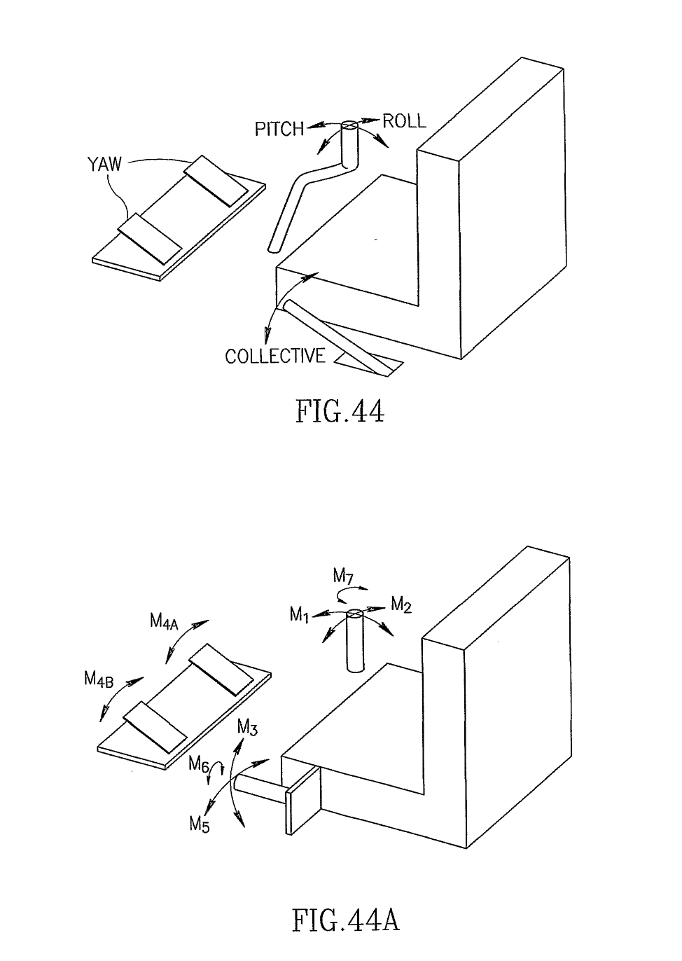

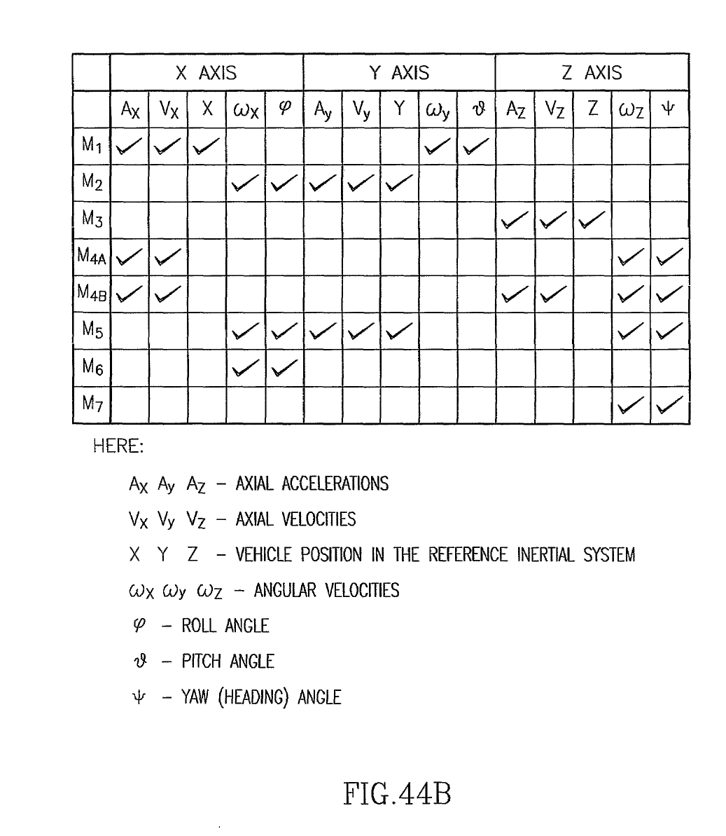

FIG. 44 shows the current cockpit control configuration commonly used in conventional helicopters, including a stick (also termed ‘cyclic control’) that controls the rotor disk inclination through a swashplate mechanism. When the pilot moves the stick to the right, the rotor disk is tilted to the right, and the helicopter produces an angular roll velocity which translates into a roll angle. At the same time, the tilted rotor produces lateral force that accelerates the helicopter to the right. This acceleration translates into lateral velocity. The same applies to the left side. When the pilot moves the stick forward, the rotor disk is tilted forward, and the helicopter starts to acquire angular velocity in pitch, while at the same time starting to accelerate forward. The linear forward acceleration and the angular velocity combine to affect forward velocity and pitch angle. The same applies to backward stick movement. One can see that in a conventional helicopter the pilot cannot control the pitch and roll angles φ,θ shown in FIG. 41 separately from the linear velocities. The pedals normally control the yaw angular velocity which translates into to the yaw angle ψ, and a collective normally controls the vertical acceleration. (Some helicopters such as Boeing-Sikorsky's Comanche have yaw control affected through the twisting of the ‘cyclic’ which is made into a 3-axis stick, replacing the pedals). Experience from helicopters shows that, generally speaking, common pilots have no problem to control up to 4 continuous parameters simultaneously, and when more parameters are required, such as for guiding weapons or cargo actuation, a co-pilot or autopilot assistance is needed.

FIG. 44A shows an example of a cockpit controls configuration for use with the ducted fan vehicles described hereinabove. In the cockpit there are two 3-axis sticks and two pedals. The right hand side (RHS) stick is shown, for example, as a side stick, but can be also installed as a center one. The left hand side (LHS) stick is shown, for example, installed nominally at a 90-degree rotation relative to the vertical axis, but can be installed at other angles as well. Each one of the sticks' movements is designated as M₁:

M₁—is the RHS stick forward-backward movement
M₂—is the RHS stick right-left movement
M₃—is the LHS stick up-down movement
M_{4A}—is the RHS pedal forward-backward movement
M_{4B}—is the LHS pedal forward-backward movement

Optionally, M_{4A} and M_{4B} are connected together such that pushing M_{4A} will result a pulling movement in M_{4B}, and vice versa. This optional connection is designated as M₄. This arrangement is not mandatory, and separate movement of the pedal controls is possible.

M₅—is the LHS stick right left movement
M₆—is the LHS stick twist movement
M₇—is the RHS stick twist movement

The above-described movements may also be characterized as primary pilot initiated input transducers that are coupled to primary pilot initiated flight control actuators. FIG. 44B shows an example of various combinations of primary cockpit controls and how they relate to various control aspects of the ducted fan vehicle described hereinabove. Some illustrative combinations are marked with the ✓ sign, although other combinations are possible. Since the flight control of a ducted fan vehicle is preferably digital, other possible combinations may be implemented. The implementation can be made a priori or it can be changed in real-time during flight. For example in FIG. 44B, it can be decided that M₅ can control the lateral acceleration Ay and/or the resulting lateral velocity Vy, or the roll angular acceleration and/or the resulting roll angle φ, etc. M₅ can also be used to control the yaw rate or the resulting heading angle instead of the pedals M₄, or alternatively, the pilot can switch the control during flight from M₄ to M₅, such as upon transition from fast flight to hover. Usually, in modern Fly-By-Wire (FBW) or Fly-by-light (FBL) vehicles, the pilot may not control the acceleration directly, but rather commands the desired velocities and/or angular displacements.

As shown in FIG. 44B, various DOFs of the vehicle may be interdependent, such as linear velocity being related to axial acceleration, position being related to linear velocities, and Euler angles being related to angular velocities. The geometry of the vehicle typically governs which interdependencies are present. As explained above, in a conventional helicopter it is not possible to decouple the velocities from the Euler angles. In the present invention, the autopilot may be designed so as to selectively couple more DOF to further reduce the number of the pilot-controlled DOF, or alternatively, the autopilot can be used to control two or more DOF, with the pilot controlling the remaining ones.

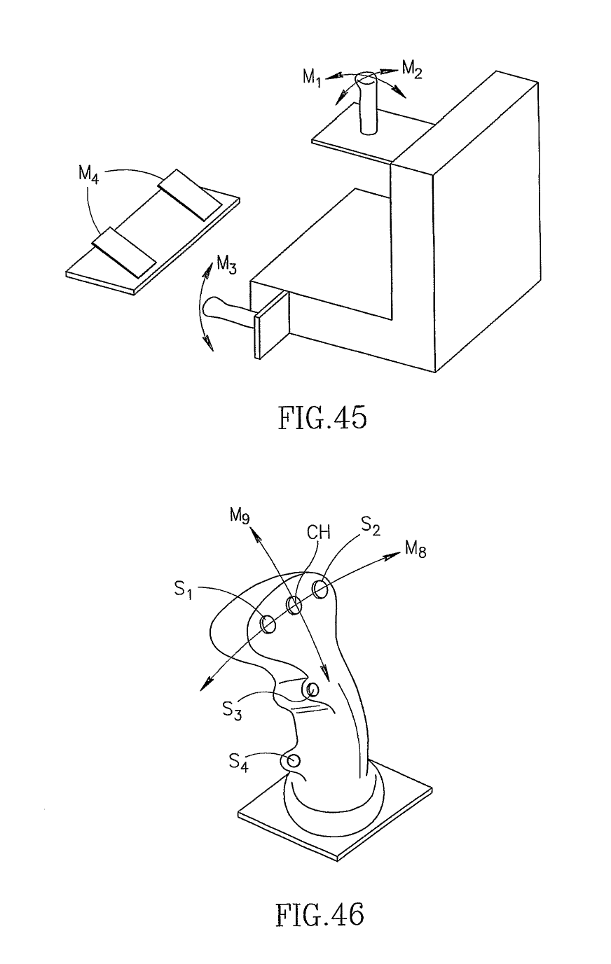

FIG. 45 shows a possible arrangement for ducted fan vehicle cockpit controls, where a two-axis side stick is located at the RHS of the pilot that moves in the directions shown M₁ and M₂. A collective control M₃ and pedals M₄ are also shown.

The following example describes some optional possibilities available in the design of the autopilot for the ducted fan vehicles described hereinabove. It is customary to divide the flight envelope of helicopters and also of the ducted fan vehicles described hereinabove into two main zones: 1) hover and low speed flight (LSF) and 2) high speed flight (HSF). The transition velocity between these zones is unique to each vehicle, but, for example, one can say that the first zone is up to 40 Knots, while the second zone is from 40 Knots up to the maximum velocity Vmax. As explained above, the autopilot of the ducted fan vehicle with 6 DOF described hereinabove may optionally govern two of the six DOF. FIG. 46 to FIG. 52 show various possible combinations of interdependent DOF to enhance the agility and controllability of the ducted fan vehicles described hereinabove.

For example, in the hover and LSF zone the autopilot can optionally control some preset roll and pitch angles according to predefined angles, and the pilot will have control over the vehicle as follows:
M₁ will control the longitudinal velocity Vx flying forward and backward. Pushing the stick forward will increase the forward speed, and pulling the stick backward will reduce the forward speed to zero, and if kept pulled, will increase the backward speed. At zero movement the autopilot will maintain zero velocity. The controlled velocity will be proportional to the stick movement.
M₂ will control the lateral velocity Vy. Moving the stick to the right will increase Vy to the right, and moving the stick to the left will reduce the lateral speed to the right to zero, and if kept to the left, will increase Vy to the left. The controlled velocity will be proportional to the stick movement.
M₃ will control the vertical velocity Vz. Raising the collective upward will increase the upward velocity Vz, and lowering the collective reduce the upward velocity Vz to zero, and if kept in the low position will increase the downward velocity. The controlled velocity will be proportional to the collective movement.

All velocities may optionally be relative to the ground or to any other inertial reference, or even to the mass of air surrounding the vehicle (sometimes termed ‘wind axes’), facilitated by through the measurement of anemometric data such as barometric altitude and Pitot-static derived airspeed or their combination.
M₄ will control the yaw rate of the vehicle. Pushing the right pedal will increase the yaw rate to the right and pushing the left pedal will increase the yaw rate to the left. The controlled yaw rate will be proportional to the pedals movement. It should be noted that for the ducted fan vehicles described hereinabove, the yaw rate can be controlled either by moving the vanes differentially between the forward and aft ducts or by differential pitch at the TFU or by combinations of these two control methods.

FIG. 46 shows a method for changing the preset pitch and roll angles of a ducted fan vehicle such as described hereinabove, using ‘conventional’ stick controllers. A “Coolie Hat” device (CH) normally located on the upper part of the stick as shown, can move left and right (M₈) or up and down (M₉). M₉ may be used to increase or decrease the preset pitch angle, and M₈ may be used to increase or decrease the preset roll angle. The change can be proportional to the CH movement, proportional to the time the CH is kept at a certain position, at fixed steps, or implemented using any other changing method. For example, the vehicle may hover by default at a zero preset roll angle, whereupon, by pushing M₈ to the right, the preset roll angle will be changed to 2 degrees, or another preset amount, and the autopilot maintains the hover at that 2 degrees right roll angle. Beside the CH there are two switches, S1 and S2, which can be used to reset the preset pitch and roll angles back to predefined default settings. The CH controls and switches S1 and S2 may be characterized as relating to secondary or non-primary pilot initiated controls, coupled to non-primary flight control actuators. Alternatively, some CH type controls are equipped with a substantially center push function which can be used to zero out all previously induced angular displacements with one “push”. The combination described above may be utilized in various ‘stick’ type controllers such for example as those shown in FIGS. 44A, 45, 53,54 and 55.

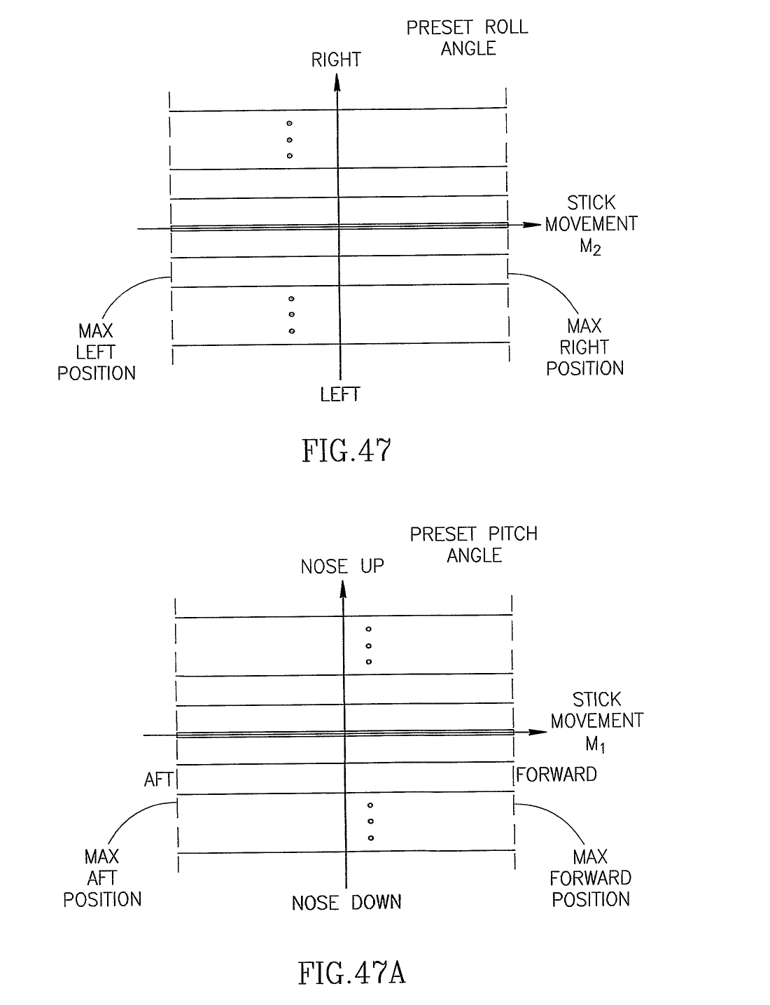

FIG. 47 shows graphically the schematic relationship between preset roll angle and the stick movement M₂ as described above. The baseline setting preferably maintains a zero roll angle at all M₂ setting. When the pilot moves M₂, the vehicle preferably does not roll at all and will only produce lateral velocity Vy. The autopilot will calculate and control the proper position of the VCS, main lift rotors pitch, TFU pitch, and/or any other controllable parameter in the vehicle, in order to affect this desired result. By changing the preset roll angle with M₈ the autopilot preferably maintains a non-zero roll angle and will calculate the proper position of the said controllable parameters as was explained with regards to FIG. 42.

FIG. 47A shows graphically the schematic relationship between the preset pitch angle and the stick movement M_{I}. The baseline setting is preferably set to maintain a zero pitch angle at all M₁ settings. When the pilot moves M_{I}, the vehicle preferably does not pitch and only produces longitudinal velocity Vx. The autopilot preferably calculates the proper positions of the VCS, main lift rotors pitch, TFU pitch, and/or any other controllable parameter in the vehicle in order to affect maintain this result. By changing the preset pitch angle with CH M₉ controller the autopilot preferably maintains the desired non-zero pitch angle and calculates the proper positions of the relevant controls as was explained with regards to FIG. 42A.

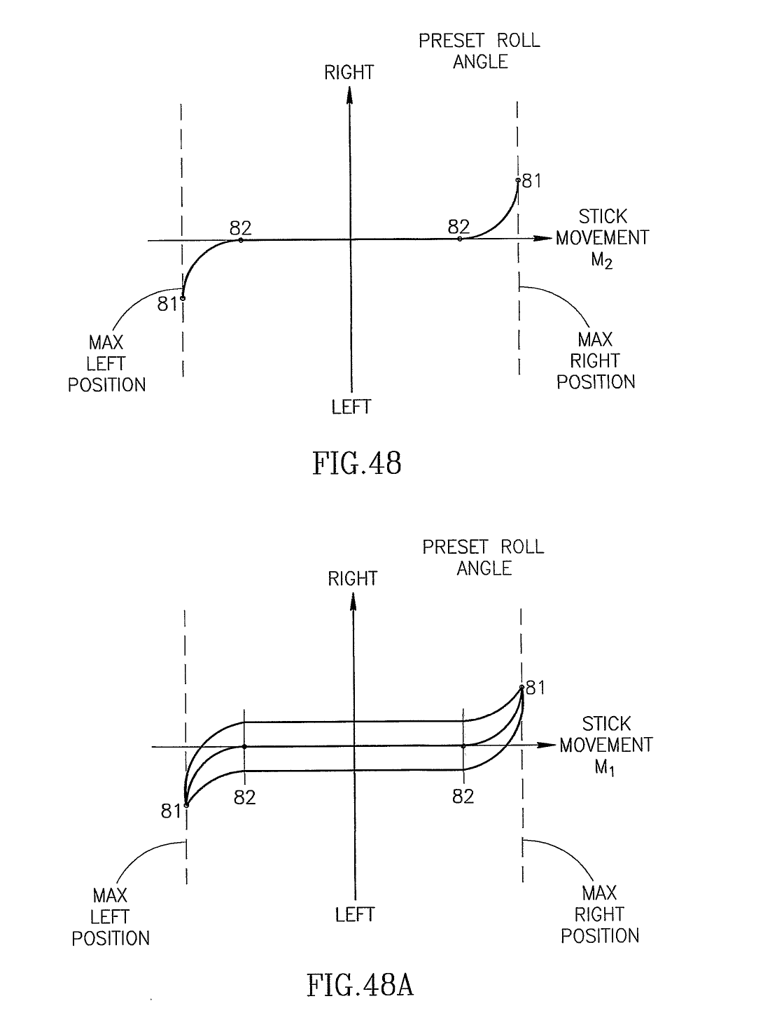

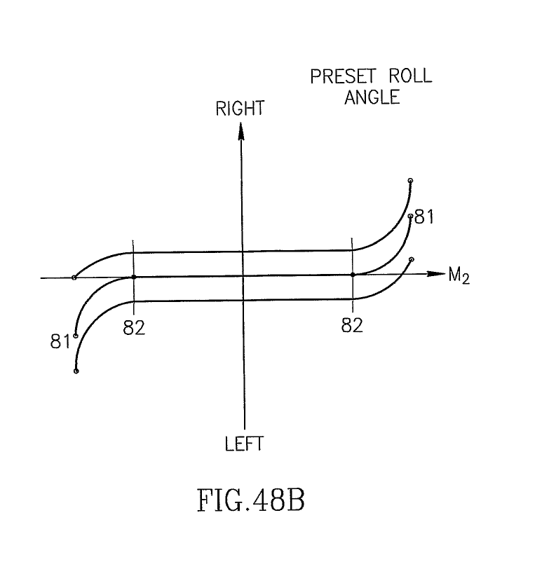

FIG. 48 shows an alternative possible relationship between the stick movement M₂ and the preset roll angle. In this setting the preset roll angle will deviate automatically from the default zero setting near some designated point 82 toward a non-zero roll angle at the maximum stick setting designated 81. This setting will increase the agility of the vehicle because in case the pilot moves the stick beyond point 82, (in itself an indication that the pilot requests a strong response), by beginning to roll the lift rotors will contribute to the lateral force needed to maintain a higher lateral acceleration, and the commanded lateral velocity will be achieved faster. Alternatively, the added lateral force can be used to increase the maximum lateral speed. This relationship can also be used in cases where the regular control force is not enough. The pilot can switch to this mode and have more control power.

FIG. 48A and FIG. 48B show an alternative relationship between the preset roll angle and M₈. In FIG. 48A the graph line is moved in parallel to the default reference line, but points 81 are maintained at a constant level. In FIG. 48B the graph line is moved in parallel including point 81 which is moved at the same amount as all the other points on the graph.

In FIGS. 48, 48A, and 48B, the roll axis is shown in one exemplary configuration. A similar methodology can be applied to the pitch axis as well.

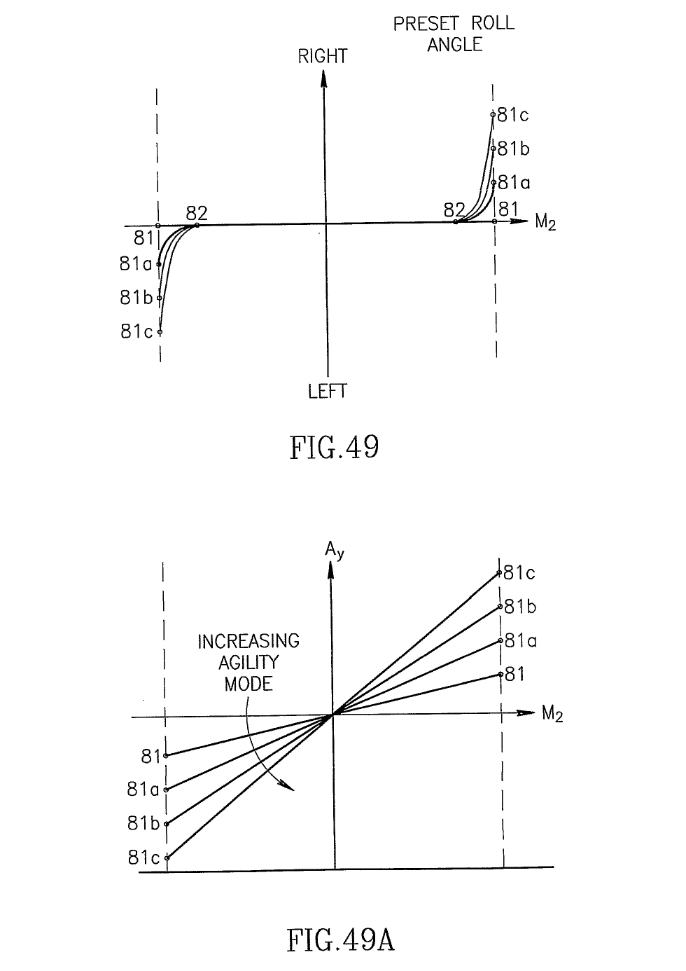

FIG. 49 graphically depicts how the lateral movement of the vehicle may be changed by the pilot changing the position of point 81. Increasing the value of point 81 will increase the final roll angle at the end of M₂ movement and will therefore increase the lateral acceleration to reduce the time to get to the commanded Vy or alternately increase the final Vy.

The pilot can change the agility mode using a switch on a stick or at any other place in the cockpit or for example by a voice command or any other method. In a further enhancement possibility, the autopilot can switch the agility mode automatically by sensing the rate by which the pilot moves the stick. It should be noted that the rate by which the pilot moves the controls in the cockpit is a powerful tool in itself and can be used also to govern the preset angles directly, or affect any other method of employing additional controls on the vehicle for boosting the response of the vehicle, thereby shortening the time required to reach the commanded motion—be it Vy, Vx or any other motion or parameter commanded by the pilot.

FIG. 49A graphically depicts the relationship between the lateral acceleration Ay and the stick movement M₂ at various agility modes 81-81c. The graph shows a linear relationship for simplicity, but a non-linear relationship may prevail also.

In FIGS. 49 and 49A the roll axis is shown in one exemplary configuration. A similar methodology can be applied to the pitch axis as well.

FIG. 50 graphically depicts the relationship between the collective stick movement M₃ and the vertical velocity Vz. The default mode may be expressed for example by the linear relationship 103. Decreasing the agility mode preferably initiates an exponential relationship 101 which will decrease the sensitivity of Vz to M₃ movement near the center of M₃ and hence increase the accuracy of the altitude control and decrease the workload of the pilot. Increasing the agility mode to 104 will increase the sensitivity of Vz to M₃ movement.

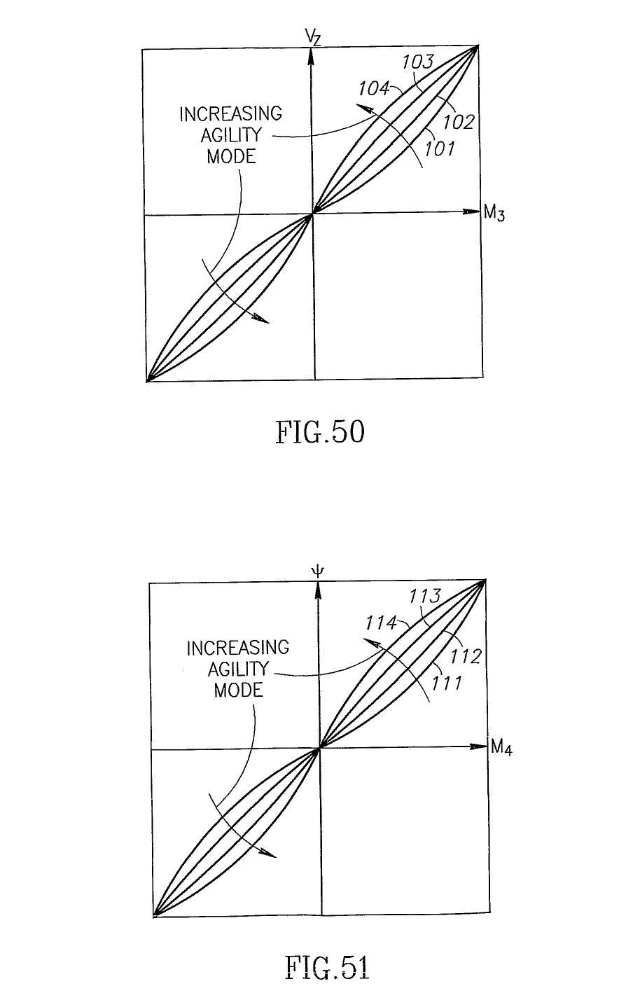

FIG. 51 graphically depicts the relationship between the pedal movement M₄ and the yaw rate. The default may be expressed by the linear relationship 113. Decreasing the agility mode preferably initiates an exponential relationship 111 which will decrease the sensitivity of the yaw rate

$$\frac{d ψ}{d t}$$

to M₄ movement near the center of M₄ and hence increase the accuracy of the heading control and decrease the workload of the pilot. Increasing the agility mode to 114 will increase the sensitivity of

$$\frac{d ψ}{d t}$$

to M₄ movement.

It will be appreciated that FIGS. 49, 49A, 50 and 51 illustrate as an example, only four agility modes, however the type and number of agility modes can be varied and different according to the requirements at hand.

At medium and high flight (HSF) the functionality of the controls may be changed as follows although as already mentioned, other combinations are possible:
M₁ will remain the same as in hover and LSF.
M₂ will control the radius of turn R where at center stick position the vehicle will fly a straight line (R→∞), while by increasing the movement of M₂ to either side the vehicle will decrease R up to the minimum radius possible within aerodynamic, controllability or engine power limits. Changing R may be accompanied by an autopilot activated rolling of the vehicle to the inside of the turn in order to decrease the lateral acceleration to a comfortable value for the pilot and passengers. Alternatively, M₂ can control the rate of turn Ψ instead of the radius of turn R.
M₃ will remain the same as in LSF
M₄ will be used to change the radius of turn without changing the rolling angle by applying an additional lateral force with the VCS and/or by changing the sideslip angle. Applying M₄ will increase the lateral acceleration temporarily, even if to a less comfortable value. The pedals may include provisions to sense whether the pilot wants to change the lateral acceleration or not. These provisions may be in the form of a microswitch located on one or both of the pedals or by any other sensing means. If the pilot removes his legs from sensing means the autopilot will preferably maintain a coordinated turn with comfortable or zero lateral acceleration.

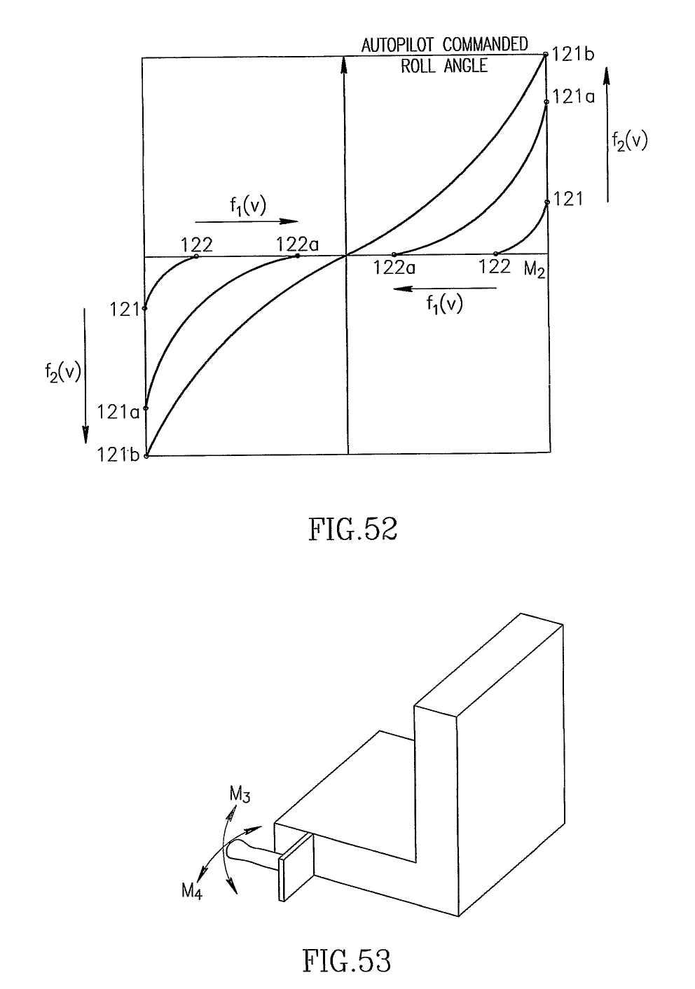

FIG. 52 graphically depicts the relationship between the autopilot commanded rolling angle and the M₂ stick movement at medium and high speed. Points 121 and 122 depict the situation at hover and LSF. When the velocity is increased, point 121 changes its value through 121a toward 121b as a function of the velocity V. Similarly, point 122 changes its value through 122a toward 122b as a function of the velocity V. These functions are shown as f1(V) and f2(V) accordingly. The functions f1(V) and f2(V) may be calculated according to the specific vehicle configuration, engine power, efficiency etc. Proper calculation of functions f1(V) and f2(V) can be used to seamlessly connect the hover & LSF and the HSF zones.

Hold modes: The autopilot may implement various hold modes including, for example, the following:
Altitude hold—below a predefined altitude (for example 300 ft) the autopilot may maintain, at the pilot's discretion, a constant altitude above ground level (AGL). Above the predefined altitude the autopilot will maintain a constant altitude above sea level (ASL). The engagement and disengagement of this mode may be provided by cockpit control, such as by switches on a stick. The stick M₃ may include provisions to command whether the pilot wants to control the vertical movement M₃ or wants the autopilot to perform altitude hold.
Velocity hold—Above a predefined velocity (for example 5 Knots) the autopilot may maintain, at the pilot's discretion, a constant velocity. The engagement and disengagement of this mode may be provided by cockpit control, such as by switches on a stick. The stick M₁ may also include provisions to command whether the pilot wants to command ‘velocity hold’ by himself (through a switch) or wants the autopilot to perform some pre-defined function of velocity hold. One possibility would for example define that up to a predefined velocity (for example 40 Knots) the velocity hold will be ground velocity, and above the predefined velocity, the velocity will be Indicated Air Speed (IAS) velocity.
Position hold—When in hover, the autopilot will, at the pilot's discretion, maintain the current position. The engagement and disengagement of this mode may be provided by cockpit control, such as by switches on a stick. Provisions will be made, such as via a Coolie Hat on the right stick, to change the current position continuously or at fixed incremental steps, such as 1 meter for each switch press.
Heading hold—Below a predefined velocity (for example 5 Knots) the autopilot will, at the pilot's discretion, maintain the current heading. The engagement and disengagement of this mode may be provided by cockpit control, such as by switches on the stick or on the pedals. Provisions will be made, such as via switches on pedals, to change the current heading continuously or at fixed incremental steps, such as 1 degree for each switch press.

FIG. 53 shows an optional alternate configuration to that shown in FIG. 45 for M₄ movement where the collective suck is a two-axis stick. M₄ is controlled with the lateral movement of this stick. In this configuration the pedals may be omitted.

Alternatively, the optional configuration in FIG. 53 may be used to control the lateral velocity Vy.

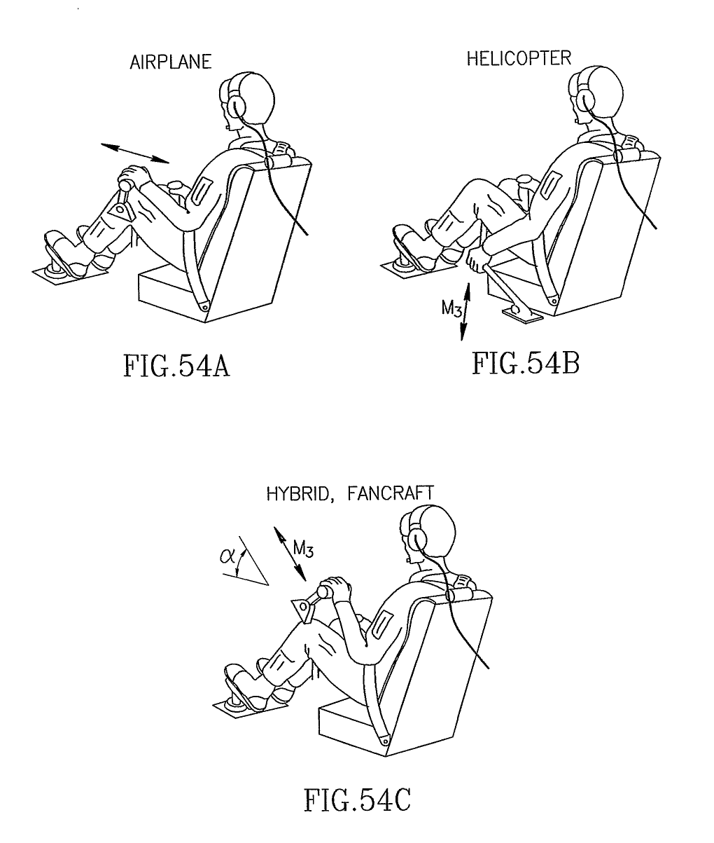

FIG. 54A-C show optional alternate configurations for controlling M₃ on ducted fan vehicles described hereinabove that may be advantageous especially for pilots that are accustomed to airplanes. FIG. 54A shows a conventional airplane configuration where a throttle that moves horizontally is used to increase engine power. By comparison, FIG. 54B shows a conventional helicopter configuration where a collective control that moves vertically is used to control the vertical velocity. Airplane pilots are not accustomed to the collective controller and may thus feel awkward in the cockpit of one of the ducted fans described hereinabove. FIG. 54C shows the proposed configuration for a ducted fan vehicle such as described hereinabove. Here the M₃ control is installed at an angle α relative to the horizontal axis, still moving up and down to signify the commanded function, but while keeping the resemblance and ‘feel’ of the conventional airplane throttle. Because both the throttle in airplanes and the collective in helicopters involve adding power to the vehicle, the combined controller that is achieved in FIG. 54C may be conceived as more ‘universal’ than the collective of FIG. 54B and may be advantageous if pilots from all branches of aviation need to feel ‘at home’ with a minimal amount of adjustment in ducted fan vehicles as described hereinabove.

The vehicle's functions that will be governed through said controller could be the vertical speed or a combination of vertical and forward speeds.

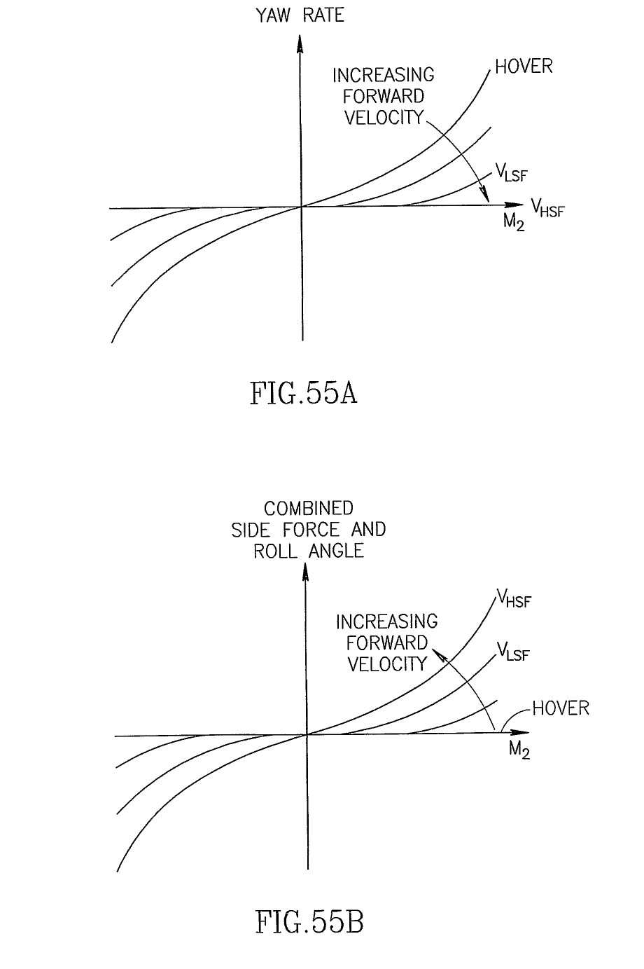

FIGS. 55A-B describe a method to control the rate of turn of a vehicle wherein the movement of stick M2 always controls the rate of turn in substantially all forward speeds envelope. In hover and LSF the said stick movement controls the rate of turn by changing the yaw rate, and in HSF it controls the rate of turn by applying a combination of side force and roll angle which can also be described as applying a centripetal force that causes the vehicle to fly in a curved path relative to the ground. One of the advantages of this embodiment is eliminating the need for the M4A and M4B controllers, because in hover and LSF condition the original function of M4A and M4B is covered by the said M2, and in HSF condition the yaw rate may be coordinated automatically by the flight control system. Since M2 was originally designated to control the lateral velocity in hover and LSF as illustrated hereinabove, in the present embodiment the lateral velocity can be controlled for example by M8 and/or M6.

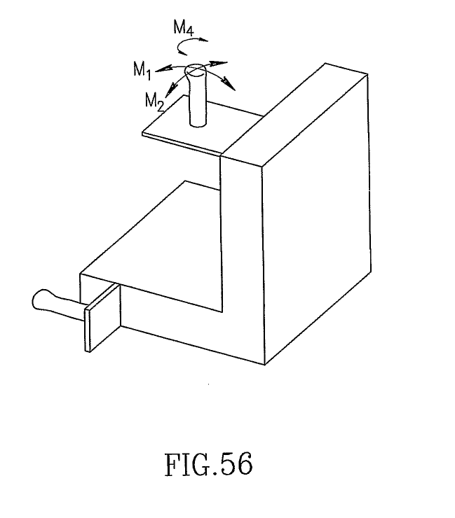

FIG. 56 shows an alternate configuration for M₄ where the RHS stick is a 3-axis stick with a twist movement that controls M₄. In this configuration the pedals may be omitted.

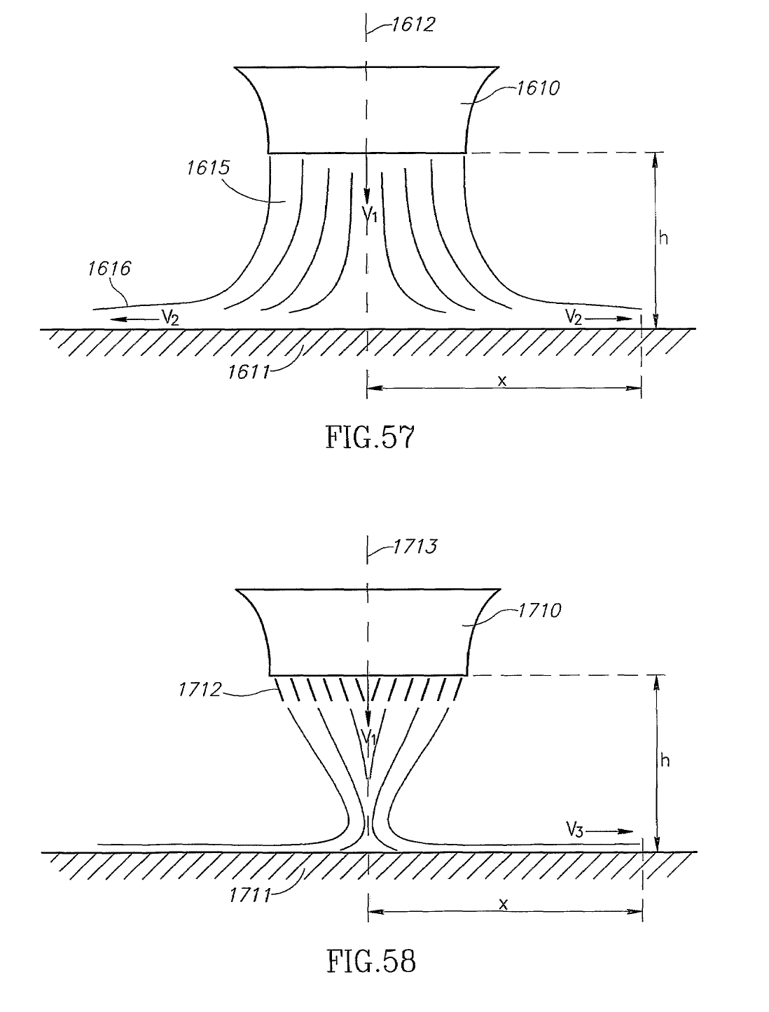

FIG. 57 schematically illustrates typical downwash and outwash flows in various VTOL vehicles, for example a ducted fan vehicle. FIG. 56 shows a ducted fan 1610 at distance h from a surface 1611, such for example as the ground, whereas the air exits the duct as downwash 1615 with velocity V1, continuing towards the ground where the wake then turns outside with reference to the vertical axis 1612 and generates outwash 1616 at velocity V2 substantially parallel to the ground surface measured at distance X from the centerline 1612. The impingement of the wake on the surface 1611 and the turn outward is also accompanied by dissipation of some of the energy of the wake due to friction, leaving less energy in the flow. Consequently the outwash velocity V2 is reduced. The dissipation is for example sensitive to the angular displacement which the flow needs to make. In the example of FIG. 56 this angular displacement is close to 90 degrees.

Experience shows that outwash flows can be detrimental causing damage by lifting debris, dust and other objects from the ground or by disturbing the vision and convenience of people surrounding the vehicle. The vanes control system (VCS) of the ducted fan vehicles described hereinabove which can be controlled from the cockpit by commands as explained herein above, may be also advantageous in reducing the outwash velocity thus reducing its damaging effects.

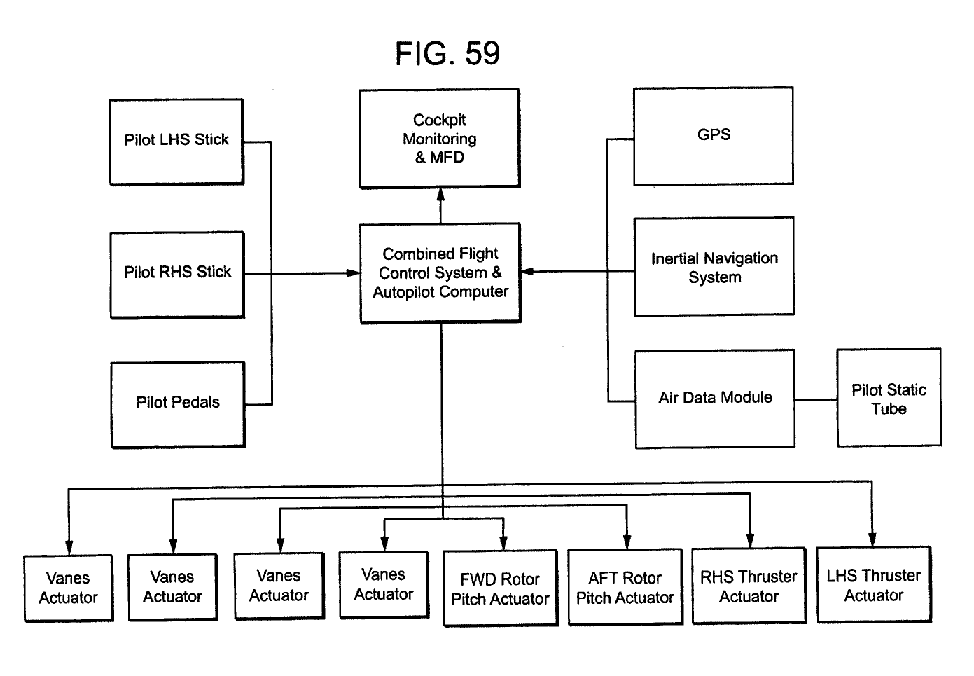

FIG. 58 schematically illustrates a ducted fan 1710 with group of control vanes 1712 installed near the exit of the duct. It will be appreciated that the vanes shown herein are merely for example purposes, and they can be placed at various positions and locations in and in the surrounding of the duct and operate symmetrically, asymmetrically and/or radially. By controlling the vanes either through the pilot's intervention from the cockpit or by command from the autopilot, the vanes are tilted inward as the vehicle approaches the ground contracting the downwash flow towards the center line 1713 yielding a sharper than 90 degree turning radius than in the example illustrated in FIG. 56. In addition, because the impingement velocity is higher, due to the contraction of the flow, the dissipation losses are also considerably higher than in the example illustrated in FIG. 56. This embodiment therefore causes greater energy dissipation and hence further reduces the outwash velocity so that V3 measured at distance X is smaller compared to velocity V2 measured at the same distance X of FIG. 56.

It should be mentioned that the modes or positions of selectively tilting of the vanes can optionally vary as function of the height h above the surface 1711 and/or the rate of decent of the vehicle and/or by any other measured parameter that affects the optimal contraction angles to minimize V3. It should also be added that from the said tilted position of the vanes, each of the vanes can be further rotated to each side typically up to stall, in order to continue performing their functions as control vanes in the ducted fan propulsion unit.

FIG. 59 is a simplified diagram of the combined flight control-autopilot system in an exemplary non-limiting embodiment illustrating pilot initiated and sensor inputs to the combined flight control system and autopilot computer, and outputs to the various vanes actuator, forward and aft rotor pitch actuators, the thruster actuators and a cockpit monitoring module. This control arrangement may be replicated for each of the independent FCS groups illustrated in FIG. 40. It will be appreciated however, that the above-described flight control/autopilot system may be employed in systems with fewer or even no redundancy control features.

In the arrangement shown in FIG. 59, the hardware may be selected from off-the-shelf components, with appropriate software utilized to implement the various functionalities. For example, the Pilot LHS and RHS sticks may be obtained from BG Systems of 3272 Bryant St., Palo Alto, Calif. 94306 (Cat. No. JF3-1-00-00-00); the cockpit monitoring module may be obtained from Chelton Flight Systems of 1109 Main Street, No. 560, Boise, Id. 83702; the Combined Flight Control System and Autopilot Computer may be obtained from RADA Electronic Industries, Ltd. of 7 Giborei Israel St., Netanza, Israel 42503; the Inertial Navigation System may be obtained from Inertial Science, Inc. of 3533 Old Conejo Rd., Suite 104, Newbury Park, Calif. 91320 (part no. DMARS-1); the Air Data Module may be obtained from Motorola, Inc. of 1303 E. Algonquin Rd., Schaumburg, Ill. 80196 (MPX Series); and the various actuators may be obtained from MPC Products Corp. of 7426 N. Linder Ave., Skokie, Ill. 60077. The Pilot Pedals, GPS and Pitot Static Tube may be obtained from any of several suitable manufacturers.

While the embodiments described above relate particularly to air vehicles, it will be appreciated that the invention, or various aspects of the invention can also be advantageously used with other types of aircraft control, such as by providing the control path redundancy described in FIG. 34 to collective and cyclic control mechanisms, tail rotor controls, or any other types of controls typically found in other fixed-wing or rotory-wing aircraft. Also it will be appreciated that the invention, or various aspects of the invention as described above can be advantageously used with other non flying control systems whereas the CPx is the control power required to maintain its survival or operation after the failure, as explained above.

While the invention has been described with respect to several preferred embodiments, it will be appreciated that these are set forth merely for purposes of example, and that many other variations, modifications and applications of the invention will be apparent.

What is claimed is:

1. A ducted fan VTOL vehicle comprising:
a thrust-generating system of plural controlled ducted air movement units having controlled propellers or fans located within respective ducts and having means capable of generating independent forces and moments in any of six fundamental degrees of freedom while operating within at least some part of a flight envelope, said six degrees of freedom comprising linear movements of the vehicle Vx, Vy, Vz and angular movements of the vehicle ωx, ωy, ωz along the axes x, y, z wherein each movement may be independently controlled;
a system of pilot initiated input transducers M1-Mn coupled to pilot initiated control actuators accessible to a pilot's position in the vehicle and producing controlled outputs corresponding to pilot initiated inputs, at least some of said transducers M1-Mn being coupled to primary pilot initiated flight control actuators, said primary pilot initiated flight control actuators being those actuators that, if active, require substantially continuous pilot attention and control inputs for maintaining primary control of vehicular movement;
autopilot and flight control systems configured to provide output flight control signals controlling physical parameters of the thrust-generating system in response to input signals;
said control systems being connected to said system of pilot initiated input transducers and adapted to control physical parameters of the thrust-generating system in response to outputs of selected ones of the pilot initiated input transducers and in response to additional vehicle transducers;
wherein said control systems are configured, while operating in said at least some part of a flight envelope, to utilize four or less primary pilot initiated flight control actuators for primary control of the vehicle while also automatically controlling all said six independent degree(s) of freedom in vehicular movement.

2. A ducted fan VTOL vehicle as in claim 1 wherein:
said control systems are capable of being re-configured in real-time during flight so as to change functional assignments for selected pilot initiated control transducers.

3. A ducted fan VTOL vehicle as in claim 1 wherein said primary pilot initiated flight control actuators comprise control sticks and pedals and wherein:
M1 corresponds to forward/backward movement of a RHS control stick mounted on the right side of the pilot's position;
M2 corresponds to right/left movement of the RHS control stick;
M3 corresponds to up/down movement of a LHS control stick mounted on the left side of the pilot's position;
M4 corresponds to forward/backward movement of a pedal mounted for actuation by at least one of the pilot's feet;
M5 corresponds to right/left movement of the LHS control stick;
M6 corresponds to twisting movement of the LHS control stick; and
M7 corresponds to twisting movement of the RHS control stick.

4. A ducted fan VTOL vehicle as in claim 3 wherein M5 controls one of the following vehicle movement parameters:
lateral acceleration Ay; lateral velocity Vy; roll angular acceleration; resulting roll angle φ; yaw rate; resulting heading angle.

5. A ducted fan VTOL vehicle as in claim 3 wherein a pilot-controlled re-configuration switch switches control functions from M4 controlling yaw rate or resulting heading angle to M5.

6. A ducted fan VTOL vehicle as in claim 1 wherein some degrees of freedom of the vehicle are interdependent during some part of a flight envelope: (a) linear velocity being related to axial acceleration; (b) position being related to linear velocities; and Euler angles φ, θ, ψ being related to angular velocities; and wherein:
the control systems selectively control increased numbers of said physical parameters of the thrust-generating system while operating in such part of a flight envelope to further reduce the number of said physical parameters of the thrust-generating system subject to pilot initiated control.

7. A ducted fan VTOL vehicle as in claim 3 wherein a flight envelope of the vehicle is divided into two main zones (a) hover and low speed flight (LSF) and (b) high speed flight (HSF), and wherein during LSF:
the control systems are configured to control some preset roll and pitch angles while pilot initiated control over the vehicle is provided as follows:
(i) M1 controls longitudinal velocity Vx flying forward and backward with velocity being proportional to stick movement;
(ii) M2 controls lateral velocity Vy flying to the left and right with velocity being proportional to stick movement;
(iii) M3 controls vertical velocity Vz flying up and down with velocity being proportional to stick movement; and
(iv) M4 controls yaw rate increasing yaw rates to left and right with yaw rate being proportional to pedal movement.

8. A ducted fan VTOL vehicle as in claim 3 wherein some of said pilot initiated transducers are coupled to non-primary flight control actuators including a coolie hat located on the upper part of a control stick and wherein:
M8 corresponds to left/right movement of said coolie hat; and
M9 corresponds to up/down movement of the coolie hat.

9. A ducted fan VTOL vehicle as in claim 8 wherein:
(i) M8 controls increase/decrease a preset roll angle; and
(ii) M9 controls increase/decrease of a preset pitch angle.

10. A ducted fan VTOL vehicle as in claim 9 wherein the change caused by the coolie hat is in conformance with one of the following: (a) proportional to coolie hat movement; (b) proportional to the time the coolie hat is kept at a certain position; (c) at fixed pre-determined steps; (d) automatic hover at zero preset roll angle which roll angle is changed to a fixed left or right roll angle by moving the coolie hat to the left or right.

11. A ducted fan VTOL vehicle as in claim 10 wherein said non-primary pilot initiated control actuators include a reset switch is accessible to the pilot's position for resetting preset pitch and roll angle back to pre-defined default settings.

12. A ducted fan VTOL vehicle as in claim 3 wherein the control systems, under at least some flight conditions, maintain a predetermined relationship between preset roll angle and stick movement M2 as shown in FIG. 47.

13. A ducted fan VTOL vehicle as in claim 3 wherein the control systems, under at least some flight conditions, maintain a predetermined relationship between preset pitch angle and stick movement M1 as shown in FIG. 47A.

14. A ducted fan VTOL vehicle as in claim 3 wherein the control systems, under at least some flight conditions, maintain a predetermined relationship between stick movement M2 and a preset roll angle as shown in FIG. 48.

15. A ducted fan VTOL vehicle as in claim 9 wherein the control systems, under at least some flight conditions, maintain a predetermined relationship between preset roll and/or pitch angle(s) and M8 as shown in FIG. 48A.

16. A ducted fan VTOL vehicle as in claim 9 wherein the control systems, under at least some flight conditions, maintain a predetermined relationship between preset roll and/or pitch angle(s) and M8 as shown in FIG. 48B.

17. A ducted fan VTOL vehicle as in claim 8 wherein said non-primary pilot initiated control actuators include an agility mode switch is accessible to pilot command for changing a relationship between at least one of the Mn control movements and the vehicle control effected by said control systems.

18. A ducted fan VTOL vehicle as in claim 17 wherein said agility mode switch is pilot accessible via voice command.

19. A ducted fan VTOL vehicle as in claim 17 wherein said agility mode switch is pilot accessible via the rate by which a pilot effects at least one of the Mn control movements.

20. A ducted fan VTOL vehicle as in claim 3 wherein the control systems, under at least some flight conditions, maintain a predetermined relationship between lateral acceleration Ay and stick movement M2 at one of the agility modes depicted in FIGS. 49 and 49A.

21. A ducted fan VTOL vehicle as in claim 3 wherein the control systems, under at least some flight conditions, maintain a predetermined relationship between vertical velocity Vz and stick movement M3 at one of the agility modes depicted in FIG. 50.

22. A ducted fan VTOL vehicle as in claim 3 wherein the control systems, under at least some flight conditions, maintain a predetermined relationship between yaw rate and pedal movement M4 at one of the agility modes depicted in FIG. 51.

23. A ducted fan VTOL vehicle as in claim 3 wherein, during high speed flight, the functionality of the controls are as follows:
M1 remains the same as in hover and low speed flight;
M2 controls the radius of turn R where, at center stick position, the vehicle will fly a straight line which, by increasing movement of M2 to either side, the vehicle will decrease R up to a minimum radius;
M3 remains the same as in low speed flight; and
M4 changes the radius of turn without changing roll angle.

24. A ducted fan VTOL vehicle as in claim 3 wherein the control systems, under at least some flight conditions, maintain a predetermined relationship between roll angle and stick movement M2 at one of the agility modes depicted in FIG. 52.

25. A ducted fan VTOL vehicle as in claim 3 wherein a non-primary pilot initiated control transducer includes a pilot accessible switch or transducer which causes the control systems, under at least some flight conditions, to maintain a constant altitude with respect to a pre-determined reference including one of: above ground or above sea level or a combination of both.

26. A ducted fan VTOL vehicle as in claim 3 wherein a non-primary pilot initiated control actuator includes a pilot accessible switch which causes the control systems, under at least some flight conditions, to maintain a constant pre-defined velocity with respect to a pre-determined reference including one of: ground speed or air speed.

27. A ducted fan VTOL vehicle as in claim 3 wherein a non-primary pilot initiated control actuator includes a pilot accessible switch which causes the control systems, under constant hover flight conditions, to move to a new constant hover position at a predetermined distance from the present position.

28. A ducted fan VTOL vehicle as in claim 27 wherein said pilot accessible switch causes the control systems to continue to move to new predetermined positions until further commanded.

29. A ducted fan VTOL vehicle as in claim 3 wherein the LHS is a two axis stick and yaw rate is controlled with the lateral movement of the LHS.

30. A ducted fan VTOL vehicle as in claim 3 wherein the LHS is a two axis stick and lateral velocity Vy is controlled with the lateral movement of the LHS.

31. A ducted fan VTOL vehicle as in claim 3 wherein the LHS M3 control comprises a push/pull lever mounted at an inclined angle α with respect to the pilot's position so as to retain some resemblance to a conventional airplane throttle control.

32. A ducted fan VTOL vehicle as in claim 3 wherein the RHS stick is a 3-axis stick with a twist movement that controls yaw rate and providing the M4 control input instead of pedal(s).

33. A ducted fan VTOL vehicle as in claim 1 having a plurality of independent autopilot and flight control systems connected between the pilot initiated input transducers and said thrust-generating system, wherein:
each independent autopilot and flight control system is coupled between said pilot initiated input transducers and said thrust generating system so as to provide at least partially redundant control over vehicular movements.

34. A flight control system for a VTOL vehicle having at least two lift fans with adjustable-pitch propellers, and at least two thrust fans with adjustable pitch propellers, and a plurality of adjustable directional vanes and associated with each of said lift and thrust fans; the control system comprising:
a. plural controls respectively controlling six independent degrees of freedom of vehicular movement; and
b. at least one control computer subsystem programmed to adjust said directional vanes and to control the pitch of said propellers of said lift and thrust fans to enable the VTOL vehicle to hover at a non-zero roll or pitch angle.

35. The flight control system of claim 34 wherein said at least one control computer subsystem is programmed to enable the VTOL vehicle to hover at both a non-zero pitch angle and a non-zero roll angle.

36. The flight control system of claim 34 wherein pilot input to said control computer subsystem is via a cockpit control configuration that includes a pair of three-axis control sticks and a pair of pedals.

37. The flight control system of claim 36 wherein movements of said three-axis control sticks and said pair of pedals are configured to control movements of the vehicle in accordance with the chart in FIG. 44B.

38. The flight control system of claim 34 comprising autopilot and flight control systems programmed to selectively increase or decrease the number of degrees of freedom controlled by the pilot of the VTOL vehicle.

39. The flight control system of claim 38 wherein the autopilot and flight control systems govern at least two of the six degrees of freedom.
